(19) United States
(12) Patent Application Publication
(10) Pub. No.: US 2025/0274906 A1
(43) Pub. Date: Aug. 28, 2025

(54) METHOD AND APPARATUS FOR HANDLING UPLINK RESOURCES CONFIGURATION AND SELECTION FOR AMBIENT IOT DEVICE IN A WIRELESS COMMUNICATION SYSTEM

(71) Applicant: ASUS Technology Licensing Inc., Taipei City (TW)

(72) Inventors: Wei-Han Lai, Taipei City (TW); Yi-Hsuan Huang, Taipei City (TW); Meng-Hui Ou, Taipei City (TW); Yu-Hsuan Guo, Taipei City (TW); Ming-Che Li, Taipei City (TW)

(21) Appl. No.: 19/059,002

(22) Filed: Feb. 20, 2025

Related U.S. Application Data
(60) Provisional application No. 63/557,419, filed on Feb. 23, 2024.
(60) Provisional application No. 63/557,426, filed on Feb. 23, 2024.
(60) Provisional application No. 63/563,305, filed on Mar. 8, 2024.

(51) Int. Cl. H04W 68/00; H04W 72/044; H04W 74/0838

(52) U.S. Cl. CPC H04W 68/00; H04W 72/044; H04W 74/0838

(57) ABSTRACT

Methods, systems, and apparatuses are provided for handling uplink resources configuration and selection for ambient Internet of Things (IoT) devices in a wireless communication system, wherein a method of a User Equipment (UE) comprises receiving a paging for ambient IoT indicating at least one or more Identifications (IDs) of multiple UEs comprising an ID of the UE and at least one configuration related to multiple contention-free radio resources, selecting, in response to receiving the paging, a first radio resource from the multiple contention-free radio resources, and performing a first transmission using the first radio resource.

### CROSS-REFERENCE TO RELATED APPLICATIONS

The present Application claims priority to and the benefit of U.S. Provisional Patent Application Ser. No. 63/557,419, filed Feb. 23, 2024, U.S. Provisional Patent Application Ser. No. 63/557,426, filed Feb. 23, 2024, and U.S. Provisional Patent Application Ser. No. 63/563,305, filed Mar. 8, 2024; with each of the referenced and identified applications and disclosures fully incorporated herein by reference.

### FIELD

This disclosure generally relates to wireless communication networks and, more particularly, to a method and apparatus for handling uplink resources configuration and selection for ambient Internet of Things (IoT) devices in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided for handling uplink resources configuration and selection for ambient Internet of Things (IoT) devices in a wireless communication system. A lightweight signaling procedure could be achieved for an ambient IoT User Equipment (UE) to perform transmissions and signaling overhead could be reduced. The ambient IoT UE could transmit and receive data and/or signaling using proper resources. Multiple ambient IoT UEs could receive a single message to trigger transmissions and acquire proper resources to perform the transmissions.

In various embodiments, a method of a UE comprises receiving a paging for ambient IoT indicating at least one or more Identifications (IDs) of multiple UEs comprising an ID of the UE and at least one configuration related to multiple contention-free radio resources, selecting, in response to receiving the paging, a first radio resource from the multiple contention-free radio resources, and performing a first transmission using the first radio resource.

In various embodiments, a method of a reader comprises transmitting a paging for ambient IoT, wherein the paging indicates at least one or more IDs of multiple UEs comprising an ID of a UE and at least one configuration related to multiple contention-free radio resources, and receiving a first transmission from the UE via a first radio resource among the multiple contention-free radio resources in response to the paging.

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5 is a reproduction of FIG. 4.2.1.1-1: Topology 1, from 3GPP TR 38.848 V18.0.0 (2023-09).

FIG. 6 is a reproduction of FIG. 4.2.1.2-1: Topology 2, from 3GPP TR 38.848 V18.0.0 (2023-09).

FIG. 7 is an example flow diagram showing that an ambient IoT UE may need to do one or more various steps to perform UL transmissions, in accordance with embodiments of the present invention.

FIG. 8 is a flow diagram of a method of a first UE in a wireless communication system comprising determining or deriving (at least) a first configuration by a first method, wherein the first configuration is determined or derived by a second UE by a second method or is not determined or derived by the second method, in accordance with embodiments of the present invention.

FIG. 9 is a flow diagram of a method of a network node in a wireless communication system comprising configuring a first UE with (at least) a first configuration by a first method, and/or configuring a second UE with (at least) the first configuration by a second method, in accordance with embodiments of the present invention.

FIG. 10 is a flow diagram of a method of a first UE in a wireless communication system comprising performing resource selection steps, and performing a transmission or reception without at least a first configuration, wherein the first configuration is required by a second UE to perform the transmission or reception, in accordance with embodiments of the present invention.

FIG. 11 is a flow diagram of a method of a UE in a wireless communication system comprising receiving a paging for ambient IoT indicating at least one or more IDs of multiple UEs comprising an ID of the UE and at least one configuration related to multiple contention-free radio resources, selecting, in response to receiving the paging, a first radio resource from the multiple contention-free radio resources, and performing a first transmission using the first radio resource, in accordance with embodiments of the present invention.

FIG. 12 is a flow diagram of a method of a reader in a wireless communication system comprising transmitting a paging for ambient IoT, wherein the paging indicates at least one or more IDs of multiple UEs comprising an ID of a UE and at least one configuration related to multiple contention-free radio resources, and receiving a first transmission from the UE via a first radio resource among the multiple contention-free radio resources in response to the paging, in accordance with embodiments of the present invention.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WIMAX®, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] RP-234058, “Study on solutions for Ambient IoT (Internet of Things) in NR.”; [2] 3GPP TR 38.848 V18.0.0 (2023-09) 3GPP; TSG RAN; Study on Ambient IoT (Internet of Things) in RAN (Release 18); [3] 3GPP TS 38.321 V18.0.0 (2024-01) 3GPP; TSG RAN; NR; MAC protocol specification (Release 18); [4] 3GPP TS 38.331 V18.0.0 (2024-01) 3GPP; TSG RAN; NR; RRC protocol specification (Release 18); and [5] 3GPP TS 38.214 V18.1.0 (2023-12) 3GPP; TSG RAN; NR; Physical layer procedures for data (Release 18). The standards and documents listed above are hereby expressly and fully incorporated herein by reference in their entirety.

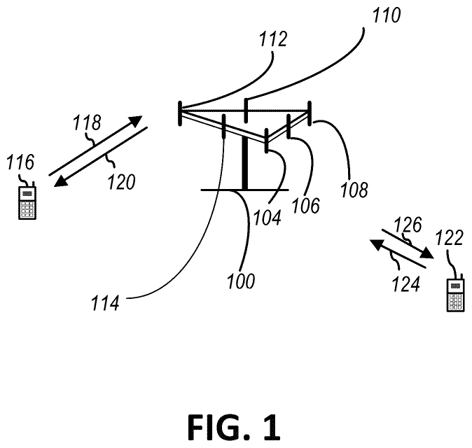

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

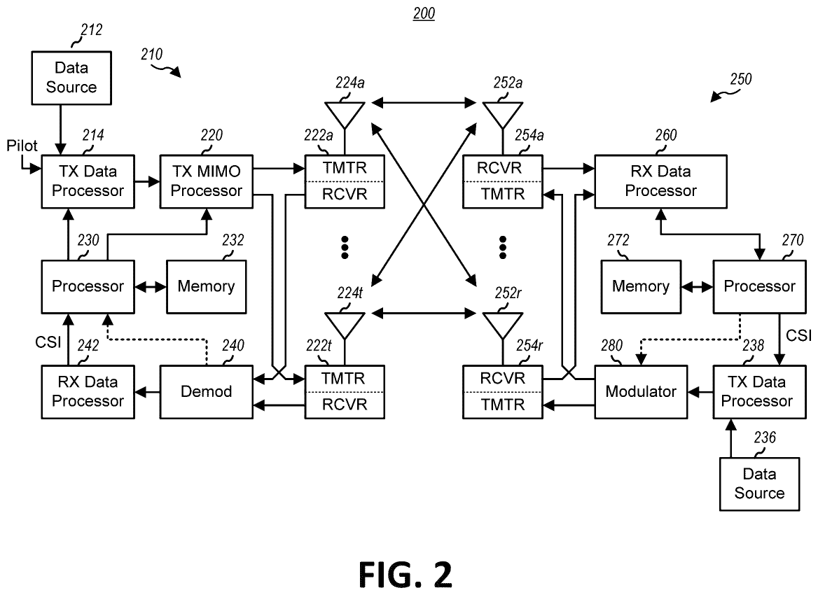

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T}“detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

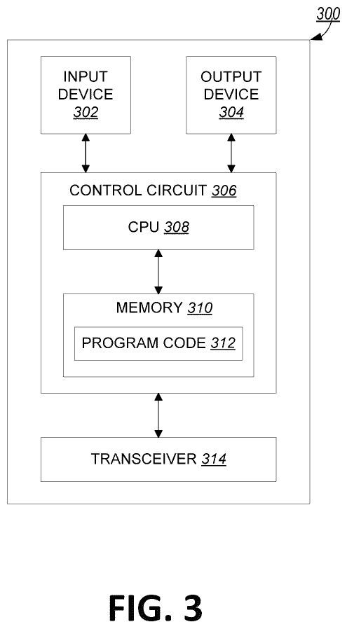

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the N_{R} system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

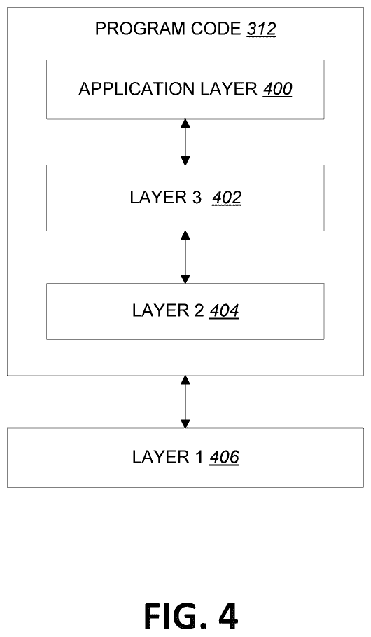

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or N_{R} systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-) bullets, points, actions, or claims described in each invention paragraph or section may be combined logically, reasonably, and properly to form a specific method.

Any sentence, paragraph, (sub-) bullet, point, action, or claim described in each of the following invention paragraphs or sections may be implemented independently and separately to form a specific method or apparatus. Dependency, e.g., “based on”, “more specifically”, “example”, etc., in the following invention disclosure is just one possible embodiment which would not restrict the specific method or apparatus.

The study item of ambient Internet of Things (IoT) has been approved in the RAN plenary #102 meeting. The description is specified in [1] RP-234058, as below:

### ***********************************Quotation Start [1] ***********************************

### 3 Justification

In recent years, IoT has attracted much attention in the wireless communication world. More ‘things’ are expected to be interconnected for improving productivity efficiency and increasing comforts of life. Further reduction of size, complexity, and power consumption of IoT devices can enable the deployment of tens or even hundreds of billion IoT devices for various applications and provide added value across the entire value chain. It is impossible to power all the IoT devices by battery that needs to be replaced or recharged manually, which leads to high maintenance cost, serious environmental issues, and even safety hazards for some use cases (e.g., wireless sensor in electric power and petroleum industry).

Most of the existing wireless communication devices are powered by battery that needs to be replaced or recharged manually. The automation and digitalization of various industries open numbers of new markets requiring new IoT technologies of supporting batteryless devices with no energy storage capability or devices with energy storage that do not need to be replaced or recharged manually. The form factor of such devices must be reasonably small to convey the validity of target use cases.

TR 22.840 is being developed by SA1 to capture use cases, traffic scenarios, device constraints of ambient power-enabled Internet of Things and identify new potential service requirements as well as new KPIs. SA1 are considering devices being either battery-less or with limited energy storage capability (i.e., using a capacitor) and the energy is provided through the harvesting of radio waves, light, motion, heat, or any other power source that could be seen suitable.

Considering the limited size and complexity required by practical applications for batteryless devices with no energy storage capability or devices with limited energy storage that do not need to be replaced or recharged manually, the output power of energy harvester is typically from 1 μW to a few hundreds of μW. Existing cellular devices may not work well with energy harvesting due to their peak power consumption of higher than 10 mW.

An example type of application in TR 22.840 is asset identification, which presently has to resort mainly to barcode and RFID in most industries. The main advantage of these two technologies is the ultra-low complexity and small form factor of the tags. However, the limited reading range of a few meters usually requires handheld scanning which leads to labor intensive and time-consuming operations, or RFID portals/gates which leads to costly deployments. Moreover, the lack of interference management scheme results in severe interference between RFID readers and capacity problems, especially in case of dense deployment. It is hard to support large-scale network with seamless coverage for RFID.

TSG RAN has completed a Rel-18 RAN-level SI on Ambient IoT, which provides a terminological and scoping framework for future discussions of Ambient IoT. This has defined representative use cases, deployment scenarios, connectivity topologies, Ambient IoT devices, design targets, and required functionalities; it also conducted a preliminary feasibility assessment, and gave recommendations for down-selection in setting the scope of a further WG-level study.

Since existing technologies cannot meet all the requirements of target use cases, a new IoT technology is recommended to open new markets within 3GPP systems, whose number of connections and/or device density can be orders of magnitude higher than existing 3GPP IoT technologies. The new IoT technology shall provide complexity and power consumption orders of magnitude lower than the existing 3GPP LPWA technologies (e.g. NB-IoT and eMTC), and shall address use cases and scenarios that cannot otherwise be fulfilled based on existing 3GPP LPWA IoT technologies.

### 4 Objective

### 4.1 Objective of SI or Core Part WI or Testing Part WI

This study targets a further assessment at RAN WG-level of Ambient IoT, a new 3GPP IoT technology, suitable for deployment in a 3GPP system, which relies on ultra-low complexity devices with ultra-low power consumption for the very-low end IoT applications. The study shall provide clear differentiation, i.e. addressing use cases and scenarios that cannot otherwise be fulfilled based on existing 3GPP LPWA IoT technology e.g. NB-IoT including with reduced peak Tx power.

### General Scope

The definitions provided in TR 38.848 are taken into this SI, and the following are the exclusive general scope:
A. The overall objective shall be to study a harmonized air interface design with minimized differences (where necessary) for Ambient IoT to enable the following devices:
   i. ˜1 μW peak power consumption, has energy storage, initial sampling frequency offset (SFO) up to 10^{X} ppm, neither DL nor UL amplification in the device. The device's UL transmission is backscattered on a carrier wave provided externally.
   ii. ≤a few hundred μW peak power consumption¹, has energy storage, initial sampling frequency offset (SFO) up to 10^{X} ppm, both DL and/or UL amplification in the device. The device's UL transmission may be generated internally by the device, or be backscattered on a carrier wave provided externally.
      X is to be decided in WGs.
      Coverage design target: Maximum distance of 10-50 m with device indoors as per TR 38.848: “ . . . a range that WGs can sub-select within”.
      For Topologies 1 & 2 (UE as intermediate node under NW control) per TR 38.848, with no RRC states, no mobility (i.e. at least no cell selection/re-selection-like function), no HARQ, no ARQ.
   NOTE 1: It is to be understood that “≤a few hundred μW” means WGs are not tasked with setting a particular value, and that it will be for WG discussions to determine if a presented design with corresponding power consumption satisfies the “≤a few hundred μW” requirement.
B. Deployment Scenarios with the following characteristics, referenced to the tables in Clause 4.2.2 of TR 38.848:
   Deployment scenario 1 with Topology 1
      Basestation and coexistence characteristics: Micro-cell, co-site
   Deployment scenario 2 with Topology 2 and UE as intermediate node, under network control
      Basestation and coexistence characteristics: Macro-cell, co-site
      The location of intermediate node is indoor
C. FR1 licensed spectrum in FDD.
D. Spectrum deployment in-band to N_{R}, in guard-band to LTE/N_{R}, in standalone band(s).
E. Traffic types DO-DTT, DT, with focus on rUC1 (indoor inventory) and rUC4 (indoor command).
   From RAN #104, the study will assess whether the harmonized air interface design (per bullet ‘A’ above) can address the DO-A (Device-originated autonomous) use case, only to identify which part(s) of the harmonized air interface design (per bullet ‘A’ above) is/are not sufficient for the DO-A use case.

Transmission from Ambient IoT device (including backscattering when used) can occur at least in UL spectrum.

The following objectives are set, within the General Scope:

2. Study necessary and feasible solutions for Ambient IoT as prescribed in the General Scope, including decisions on which functions, procedures, etc. are needed and not needed, and ensuring at least the required functionalities in Section 6.2 of TR 38.848.

Study of positioning in Rel-19 is RAN3-led, limited to functionalities which would have no, or minimal, specification impact (note: this does not imply any decision relating to WI creation).

Study the feasibility and required functionalities for proximity determination (coordination with SA3 is required for privacy aspects).
RAN1-led:
For the Ambient IoT DL and UL:
   Frame structure, synchronization and timing, random access
   Numerologies, bandwidths, and multiple access
   Waveforms and modulations
   Channel coding
   Downlink channel/signal aspects
   Uplink channel/signal aspects
   Scheduling and timing relationships
   Study necessary characteristics of carrier-wave waveform for a carrier wave provided externally to the Ambient IoT device, including for interference handling at Ambient IoT UL receiver, and at N_{R} basestation.
   For Topology 2, no difference in physical layer design from Topology 1.
RAN2-led:
   Study and decide which functions are needed for an Ambient IoT compact protocol stack and lightweight signalling procedure to enable DO-DTT and DT data transmission, and study those functions.
   For example:
      Paging
      Random access
      Data transmission, including necessary radio resource control aspects, respecting the limitation in the General Scope

### ****************************************Quotation End****************************************

The description (e.g. regarding topology and assumption) for ambient IoT could be found in [2]3GPP TR 38.848 V18.0.0:

### ****************************************Quotation Start [2] ****************************************

### 4.2.1 Connectivity Topologies

### 4.2.1.0 Introduction

The following connectivity topologies for Ambient IoT networks and devices are defined for the purposes of the study. In all these topologies, the Ambient IoT device may be provided with a carrier wave from other node(s) either inside or outside the topology. The links in each topology may be bidirectional or unidirectional.

BS, UE, assisting node, or intermediate node could be multiple BSs or UEs, respectively. The mixture of indoor and outdoor placement of such nodes is regarded as a network implementation choice. Account would need to be taken of potential impact on device or node complexity. In the connectivity topologies, this does not imply the existence of multi-hop assisting or intermediate nodes.

### 4.2.1.1 Topology 1: BS↔Ambient IoT Device

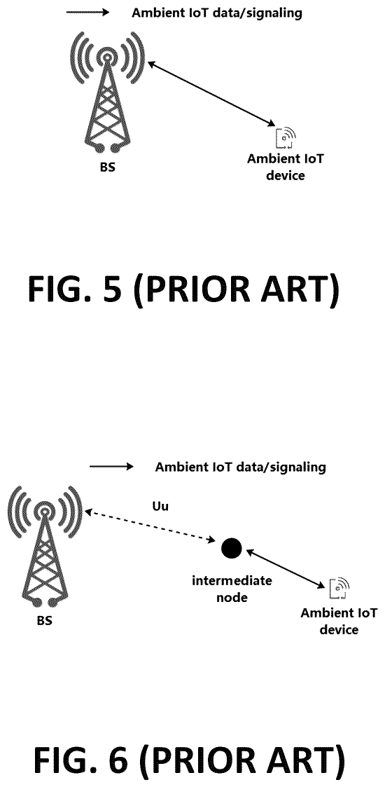

FIG. 5 Is a Reproduction of FIG. 4.2.1.1-1: Topology 1, from 3GPP TR 38.848 V18.0.0 (2023-09).

In Topology 1, the Ambient IoT device directly and bidirectionally communicates with a basestation. The communication between the basestation and the ambient IoT device includes Ambient IoT data and/or signalling. This topology includes the possibility that the BS transmitting to the Ambient IoT device is a different from the BS receiving from the Ambient IoT device.

### 4.2.1.2 Topology 2: BS↔Intermediate Node↔Ambient IoT Device

FIG. 6 is a Reproduction of FIG. 4.2.1.2-1: Topology 2, from 3GPP TR 38.848 V18.0.0 (2023-09).

In Topology 2, the Ambient IoT device communicates bidirectionally with an intermediate node between the device and basestation. In this topology, the intermediate node can be a relay, IAB node, UE, repeater, etc. which is capable of Ambient IoT. The intermediate node transfers Ambient IoT data and/or signalling between BS and the Ambient IoT device.

### ****************************************Next Quotation****************************************

### 4.3 Device Categorization

Ambient IoT devices are characterized in the study according to their energy storage capacity, and capability of generating RF signals for their transmissions.

The study considers that a device has either:
No energy storage at all; or
Limited energy storage

Relying on these storage capacities, the study considers the following set of Ambient IoT devices:
Device A: No energy storage, no independent signal generation/amplification, i.e. backscattering transmission.
Device B: Has energy storage, no independent signal generation, i.e. backscattering transmission. Use of stored energy can include amplification for reflected signals.
Device C: Has energy storage, has independent signal generation, i.e., active RF components for transmission.

A limited energy storage can be different among implementations within Device B or implementations within Device C, and different between Device B and Device C. Such storage is expected to be order(s) of magnitude smaller than an NB-IoT device would typically include.

### ****************************************Quotation End****************************************

The current random access procedure is specified in [3] 3GPP TS 38.321 V18.0.0:

### ****************************************Quotation Start [3] ****************************************

### 5.1 Random Access Procedure

### 5.1.3 Random Access Preamble Transmission

The MAC entity shall, for each Random Access Preamble:
1> if PREAMBLE_TRANSMISSION_COUNTER is greater than one; and
. . . .
1> except for contention-free Random Access Preamble for beam failure recovery request and contention-free Random Access Preamble triggered by a PDCCH order for an LTM candidate cell, compute the RA-RNTI associated with the PRACH occasion in which the Random Access Preamble is transmitted;
1> instruct the physical layer to transmit the Random Access Preamble using the selected PRACH occasion, corresponding RA-RNTI (if available), PREAMBLE_INDEX, and PREAMBLE_RECEIVED_TARGET_POWER.
1> if the Random Access Procedure is triggered by a PDCCH order for an LTM candidate cell:
   2> consider this Random Access procedure completed.
. . . .

### 5.1.3a MSGA Transmission

The MAC entity shall, for each MSGA:
. . . .
1> if this is the first MSGA transmission within this Random Access procedure:
   2> if the transmission is not being made for the CCCH logical channel:
      3> indicate to the Multiplexing and assembly entity to include a C-RNTI MAC CE in the subsequent uplink transmission.
         . . . .
   2> obtain the MAC PDU to transmit from the Multiplexing and assembly entity according to the HARQ information determined for the MSGA payload (see clause 5.1.2a) and store it in the MSGA buffer.
1> compute the MSGB-RNTI associated with the PRACH occasion in which the Random Access Preamble is transmitted;
1> instruct the physical layer to transmit the MSGA using the selected PRACH occasion and the associated PUSCH resource of MSGA (if the selected preamble and PRACH occasion is mapped to a valid PUSCH occasion), using the corresponding RA-RNTI, MSGB-RNTI, PREAMBLE_INDEX, PREAMBLE_RECEIVED_TARGET_POWER, msgA-PreambleReceivedTargetPower, and the amount of power ramping applied to the latest MSGA preamble transmission (i.e. (PREAMBLE_POWER_RAMPING_COUNTER-1)×PREAMBLE_POWER_RAMPING_STEP);

### ****************************************Quotation End****************************************

Some configurations related to paging are specified in [4] 3GPP TS 38.331 V18.0.0:

```
************************************** Quotation Start [4] ***********************************
- Paging
The Paging message is used for the notification of one or more UEs.
  ...
  Direction: Network to UE
```

| | |
|---|---|
| | Paging message |
| Paging ::= | SEQUENCE { |
| pagingRecordList | PagingRecordList |

OPTIONAL, -- Need N

| | |
|---|---|
| lateNonCriticalExtension | OCTET STRING |

OPTIONAL,

| | |
|---|---|
| nonCriticalExtension | Paging-v1700-IEs |

OPTIONAL
}

| | |
|---|---|
| Paging-v1700-IEs ::= | SEQUENCE { |
| pagingRecordList-v1700 | PagingRecordList-v1700 |

OPTIONAL, -- Need N

| | |
|---|---|
| pagingGroupList-r17 | PagingGroupList-r17 |

OPTIONAL, -- Need N

| | |
|---|---|
| nonCriticalExtension | Paging-v1800-IEs |

OPTIONAL
}

| | |
|---|---|
| Paging-v1800-IEs :: = | SEQUENCE { |
| pagingRecordList-v1800 | PagingRecordList-v1800 |

OPTIONAL, -- Need N

| | |
|---|---|
| pagingGroupList-v1800 | PagingGroupList-v1800 |

OPTIONAL, -- Need N

| | |
|---|---|
| nonCriticalExtension | SEQUENCE { } |

OPTIONAL
}

| PagingRecordList :: = | SEQUENCE (SIZE(1..maxNrofPageRec)) OF PagingRecord | | |
|---|---|---|---|
| PagingRecordList-v1700 ::= | SEQUENCE (SIZE(1..maxNrofPageRec)) OF PagingRecord-v1700 | | |
| PagingGroupList-r17 ::= | SEQUENCE (SIZE(1..maxNrofPageGroup-r17)) OF TMGI-r17 | | |
| PagingRecordList-v1800 ::= | SEQUENCE (SIZE(1..maxNrofPageRec)) OF PagingRecord-v1800 | | |
| PagingGroupList-v1800 ::= | SEQUENCE (SIZE(1..maxNrofPageGroup-r17)) OF GroupPaging-r18 | | |
| PagingRecord :: = | SEQUENCE { | | |
| ue-Identity | PagingUE-Identity, | | |
| accessType | ENUMERATED {non3GPP} | OPTIONAL, | -- Need N |

...
}

| PagingRecord-v1700 :: = | SEQUENCE { | | |
|---|---|---|---|
| pagingCause-r17 | ENUMERATED {voice} | OPTIONAL | -- Need N |

}

| PagingRecord-v1800 ::= | SEQUENCE { | | |
|---|---|---|---|
| mt-SDT | ENUMERATED {true} | OPTIONAL | -- Need N |

}

| | |
|---|---|
| PagingUE-Identity ::= | CHOICE { |
| ng-5G-S-TMSI | NG-5G-S-TMSI, |
| fullI-RNTI | I-RNTI-Value, |

...
}

| GroupPaging-r18 ::= | SEQUENCE { | | |
|---|---|---|---|
| inactiveReceptionAllowed-r18 | ENUMERATED {true} | OPTIONAL | -- Need N |

}

PagingRecord field descriptions

access Type?
Indicates whether the Paging message is originated due to the PDU sessions from the non-3GPP access.?
pagingRecordList?
If the network includes pagingRecordList-v1700, it includes the same number of entries, and listed in the same order, as?
in pagingRecordList (i.e. without suffix). If the network includes pagingRecordList-v1800, it includes the same number of?
entries, and listed in the same order, as in pagingRecordList (i.e. without suffix).?
pagingGroupList?
If the network includes pagingGroupList-v1800, it includes the same number of elements, and listed in the same order,?
as in pagingGroupList-r17. The first element corresponds to the first TMGI in pagingGroupList-r17. The second element?
corresponds to the second TMGI in pagingGroupList-r17, and so on.?
************************************** Quotation End **************************************

In [5] 3GPP TS 38.214 V18.1.0, sidelink resource allocation is specified:

### ****************************************QUOTATION [5] START****************************************

8 Physical sidelink shared channel related procedures

A UE can be configured by higher layers with one or more sidelink resource pools. A sidelink resource pool can be for transmission of PSSCH, as described in Clause 8.1, and/or SL PRS, as described in Clause 8.2.4, or for reception of PSSCH, as described in Clause 8.3, and/or SL PRS, as described in Clause 8.4.4, and can be associated with either sidelink resource allocation mode 1 or sidelink resource allocation mode 2.

A sidelink resource pool which can be used for transmission of both SL PRS and PSSCH will be referred to as shared SL PRS resource pool.

A sidelink resource pool which can be used for transmission of SL PRS and cannot be used for transmission of PSSCH will be referred to as dedicated SL PRS resource pool.
. . . .

The UE determines the set of logical slots assigned to a sidelink resource pool as follows:
a bitmap (b₀, b₁, . . . , b_{L}_{_{bitmap}}₋₁) associated with the resource pool is used where L_{bitmap} the length of the bitmap is configured by higher layers.
a slot tₖ^{SL}(0≤k<10240×2^{μ}-N_{S-SSB}−N_{nonSL}−N_{reserved}) belongs to the set if bₖ′=1 where k′=k mod L_{bitmap}.
The slots in the set are re-indexed such that the subscripts i of the remaining slots t′ᵢ^{SL} are successive {0, 1, . . . , T′ₘₐₓ−1} where T′max is the number of the slots remaining in the set.

The UE determines the set of resource blocks assigned to a sidelink resource pool as follows:
The resource block pool consists of N_{PRB} PRBs.
If the higher layer parameter transmissionStructureForPSCCHandPSSCH is not provided, or is set to ‘contiguousRB’, the sub-channel m for m=0,1, . . . , numSubchannel−1 consists of a set of n_{subCHsize} contiguous resource blocks with the physical resource block number n_{PRB}=n_{subCHRBstart}+m·n_{subCHsize}+j for j=0,1, . . . , n_{subCHsize}−1, where n_{subCHRBstart}, n_{subCHsize} and numSubchannel are given by higher layer parameters sl-StartRB-Subchannel, sl-SubchannelSize and sl-NumSubchannel, respectively.
If the higher layer parameter transmissionStructure ForPSCCHandPSSCH is set to ‘interlaceRB’, the sub-channel m for m=0,1, . . . , numSubchannel−1 consists of a set of numInterlace PerSubchannel contiguous interlaces, where each interlace consists of at least 10 resource blocks as defined in clause 4.4.4.6 of [TS 38.211]. The sub-channel m is indexed per RB set and is periodically indexed across multiple RB sets within the resource pool. The sub-channel with the same index is mapped to the set of numInterlacePerSubchannel interlace(s) with the same index(s) in different RB sets. The sub-channel #0 is mapped to interlaces 0 to numInterlace PerSubchannel−1, the subchannel #1 is mapped to interlaces numInterlacePerSubchannel to numInterlacePerSubchannel*2-1, and so on.
. . . .

### 8.1.2 Resource Allocation

In sidelink resource allocation mode 1:
for PSSCH and PSCCH transmission, dynamic grant, configured grant type 1 and configured grant type 2 are supported. The configured grant Type 2 sidelink transmission is semi-persistently scheduled by a SL grant in a valid activation DCI according to Clause 10.2A of [TS 38.213].

### 8.1.2.1 Resource Allocation in Time Domain

The UE shall transmit the PSSCH in the same slot as the associated PSCCH.

The minimum resource allocation unit in the time domain is a slot.
. . . .

In sidelink resource allocation mode 1:
For sidelink dynamic grant, the PSSCH transmission is scheduled by a DCI format 3_0.
For sidelink configured grant type 2, the configured grant is activated by a DCI format 3_0.
For sidelink dynamic grant and sidelink configured grant type 2:
   The “Time gap” field value m of the DCI format 3_0 provides an index m+1 into a slot offset table. That table is given by higher layer parameter sl-DCI-ToSL-Trans and the table value at index m+1 will be referred to as slot offset K_{SL}.
   The slot of the first sidelink transmission scheduled by the DCI is the first SL slot of the corresponding resource pool that starts not earlier than

$${T}_{D L} - \frac{{T}_{T A}}{2} + {K}_{S L} \times {T}_{s l o t} ,$$

where T_{DL} is the starting time of the downlink slot carrying the corresponding DCI, T_{TA} is the timing advance value corresponding to the TAG of the serving cell on which the DCI is received and K_{SL} is the slot offset between the slot of the DCI and the first sidelink transmission scheduled by DCI and Tₛₗₒₜ is the SL slot duration.
The “Configuration index” field of the DCI format 3_0, if provided and not reserved, indicates the index of the sidelink configured type 2.
For sidelink configured grant type 1:
   The slot of the first sidelink transmissions follows the higher layer configuration according to [TS 38.321].
. . . .

### 8.1.4 UE Procedure for Determining the Subset of Resources to be Reported to Higher Layers in PSSCH Resource Selection in Sidelink Resource Allocation Mode 2

In resource allocation mode 2, the higher layer can request the UE to determine a subset of resources from which the higher layer will select resources for PSSCH/PSCCH transmission for a carrier. To trigger this procedure, in slot n for this carrier, the higher layer provides the following parameters for this PSSCH/PSCCH transmission:
the resource pool from which the resources are to be reported;
L1 priority, prio_{TX};
the remaining packet delay budget;
number of sub-channels, L_{subCH}:
. . . .

When the resource pool is (pre-) configured with sl-AllowedResourceSelectionConfig including full sensing, and full sensing is configured in the UE by higher layers, the UE performs full sensing.

### ****************************************QUOTATION [5] END****************************************

In the 3GPP RAN1 #116 meeting, there are some agreements on Ambient Internet of Things (IoT).

For the purpose of the study, RAN1 uses the following terminologies:
Device 1: ˜1 μW peak power consumption, has energy storage, initial Sampling Frequency Offset (SFO) up to 10^{X} ppm, neither Downlink (DL) nor Uplink (UL) amplification in the device. The device's UL transmission is backscattered on a carrier wave provided externally.
Device 2a: ≤a few hundred μW peak power consumption, has energy storage, initial SFO up to 10^{X} ppm, both DL and/or UL amplification in the device. The device's UL transmission is backscattered on a carrier wave provided externally.
Device 2b: ≤a few hundred ρW peak power consumption, has energy storage, initial SFO up to 10^{X} ppm, both DL and/or UL amplification in the device. The device's UL transmission is generated internally by the device.

From the RAN1 perspective, at least when a response is expected from multiple devices that are intended to be identified, an A-IoT contention-based access procedure initiated by the reader is used.

For a A-IoT contention-based access procedure, at least a slotted-ALOHA based access is studied.

At least the following time domain frame structure is studied for A-IoT Reader to (Ambient IoT) Device (R2D) and (Ambient IoT) Device to Reader (D2R) transmission.
For R2D transmission,
   An R2D timing acquisition signal (e.g. R2D preamble) is included at least for timing acquisition and for indicating the start of the R2D transmission in time domain.
For D2R transmission,
   A D2R timing acquisition signal (e.g. D2R preamble) is included at least for timing acquisition and for indicating the start of the D2R transmission in time domain.
FFS (for further study) of other necessary component(s), e.g. midamble, postamble, periodic sync signal, control fields, guard period.

For ambient IoT devices, a dedicated physical broadcast channel for R2D, e.g. Physical Broadcast Channel (PBCH)-like, is not considered for study.

For ambient IoT devices, at least for R2D data transmission, a physical channel (Physical Reader (to Ambient IoT) Device Channel (PRDCH)) is studied,
System information (if defined) is transmitted on the PRDCH.
FFS of whether/how control information is transmitted on the PRDCH.
Note: the naming of PRDCH is used for the sake of the study.

For ambient IoT devices, at least for D2R data transmission, a physical channel (Physical (Ambient IoT) Device (to) Reader Channel (PDRCH)) is studied along with the following,
Response transmitted from device to reader during a contention-based access procedure is transmitted on the PDRCH.
   FFS: Details of response.
FFS of whether/how/what D2R control information (if defined) is transmitted on the PDRCH.
Note: the naming of PDRCH is used for the sake of the study.

In recent years, more devices are expected to be interconnected in the wireless communication world for improving productivity, efficiency, and increasing comforts of life. However, powering all the IoT devices by a battery that needs to be replaced or recharged manually would lead to high maintenance cost, environmental issues, and safety hazards for some use cases, e.g., wireless sensors in electrical power. Further reduction of size, complexity, and power consumption of IoT devices can enable the deployment for various applications (e.g., automated manufacturing, smart home).

On the other hand, barcode and Radio Frequency Identification (RFID) have a limited reading range of a few meters, which usually requires handheld scanning. It would lead to labor intensive and time-consuming operations. Also, the lack of an interference management scheme would result in severe interference between RFID readers and capacity problems, especially in the case of dense deployment. It is hard to support a large-scale network with seamless coverage for RFID. In contrast, the study of ambient IoT investigates the feasibility of a new IoT technology within 3GPP systems.

An ambient IoT device/User Equipment (UE) would have ultra-low complexity, very small device size and a long life cycle. The ambient IoT device/UE would have complexity and power consumption orders of magnitude lower than the existing 3GPP Lower Power Wide Area (LPWA) technologies (e.g., Narrowband (NB)-IoT, enhanced Machine Type Communication (eMTC)). The ambient IoT device/UE may not have energy storage or may have energy storage. The energy of the ambient IoT device/UE may be provided through the harvesting of radio waves, light, motion, heat, or any other power source that could be suitable. The energy and/or power source may be provided as a one-shot (e.g., unexpected or aperiodically), periodically, or continuously. In one embodiment, the power/energy of the Ambient IoT device/UE may be provided from a carrier wave from the network and/or an intermediate node. In Topology 1, the Ambient IoT device/UE would directly and bidirectionally communicate with a base station. In Topology 2, the Ambient IoT device/UE would communicate bidirectionally with an intermediate node (e.g., a UE or a relay node) between the Ambient IoT device/UE and the base station. The UL transmission of the ambient IoT device/UE may be generated internally by the device/UE, or be backscattered on the carrier wave provided externally. More details regarding ambient IoT (device/UE) could be found in the study item [1] RP-234058 and [2] 3GPP TR 38.848 V18.0.0.

To enable (data and/or signaling) transmission or reception, a UE should be configured and/or predefined with at least some configuration(s) related to the (data/signaling) transmission or reception beforehand. For example, the configuration may include a radio resource configuration for the (data/signaling) transmission or reception. For a normal/legacy UE in New Radio (NR), the UE may receive a common configuration via a system information, and/or receive a UE-specific configuration via a dedicated signaling (e.g., Radio Resource Control (RRC) reconfiguration). Afterwards, the UE may use/apply the radio resource to perform UL transmission with the given configuration (e.g., common configuration, UE-specific configuration). However, for an ambient IoT UE, due to characteristics of ambient IoT, such as ultra-low complexity and ultra-low power consumption, a lightweight signaling procedure should be pursued.

For the UL (data and/or signaling) transmission, an uplink timing advance may not be needed or may be set to 0. For the UL (data and/or signaling) transmission, close loop power control may not be needed. It is assumed that a Physical Broadcast Channel (PBCH) and/or system information may not be applicable for ambient IoT devices. A method for an ambient IoT UE to acquire related configuration(s) and/or resource(s) for performing UL (data and/or signaling) transmission should be designed.

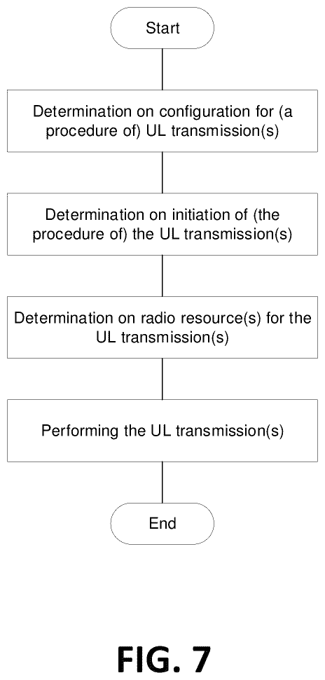

An ambient IoT UE may need to do at least (some or all of) the following step(s) to perform UL transmission(s) and an example is shown in FIG. 7:
Determination on configuration for (a (UL) procedure of) UL transmission(s).
The configuration may include at least one parameter. The configuration and/or the at least one parameter may comprise multiple parts, e.g., a first part and a second part. A first part of the at least one parameter may be received from a network. A second part of the at least one parameter may be preconfigured, predefined, or fixed. Alternatively in certain embodiments, all of the at least one parameter may be received from the network. Alternatively in certain embodiments, all of the at least one parameter may be preconfigured, predefined, or fixed. The parameter may be (or be included in) a configuration as described below.
Determination on initiation of (the (UL) procedure of) the UL transmission(s).
After the configuration is available or determined, the ambient IoT UE may need to determine whether to initiate or perform (the (UL) procedure of) the UL transmission(s). Alternatively in certain embodiments, after the ambient IoT UE determines to initiate or perform (the (UL) procedure of) the UL transmission(s), the ambient IoT UE may determine a configuration for (the (UL) procedure of) the UL transmission(s).
Determination on radio resource(s) for the UL transmission(s).
Before performing the UL transmission(s), the ambient IoT UE may need to determine the radio resource(s) to be used to transmit the UL transmission(s).
The radio resource(s) may be determined after the ambient IoT UE determines to initiate or perform (the (UL) procedure of) the UL transmission(s). Alternatively in certain embodiments, the radio resource(s) may be determined as part of the determination on whether to initiate or perform (the (UL) procedure of) the UL transmission(s). Alternatively in certain embodiments, the radio resource(s) may be determined before the ambient IoT UE determines to initiate or perform (the (UL) procedure of) the UL transmission(s) (and after the configuration is available). Alternatively in certain embodiments, the radio resource(s) may be determined as part of the determination on the configuration for (the (UL) procedure of) the UL transmission(s).
The radio resource(s) may be part of the configuration. Alternatively in certain embodiments, the radio resource(s) may not be part of the configuration. The radio resource(s) may be assigned by the network. Additionally and/or alternatively in certain embodiments, the radio resource(s) may be selected by the UE.
Performing the UL transmission(s).
The ambient IoT UE may perform the UL transmission(s) via the determined radio resource(s). The UL transmission(s) may include new transmission(s), repetition(s), and/or retransmission(s).

A first UE may determine (or derive) at least a configuration (e.g., a first configuration) by a first method. The configuration may be used for a (data or signaling) transmission or reception. The configuration may be used for a UL or DL transmission.

A network node may configure the first UE with the (first) configuration by the first method. The network node may provide the (first) configuration to the first UE by the first method.

A first UE may perform a (data or signaling) transmission or reception without (the need of) at least a configuration (e.g., a first configuration).

The network node may not (need to) configure the first UE with the (first) configuration, e.g., for the first UE to perform a (data or signaling) transmission or reception. The first UE may determine (or apply, or use) a first value for the configuration.

The method (e.g., the first method) may be (or include) one or more of the following:

Carrying Via a Common Signaling (e.g., from a Network)

The UE may receive a common signaling including or indicating at least the (first) configuration. The UE may apply the (first) configuration in response to receiving the common signaling including the (first) configuration. The UE may apply the (first) configuration in response to initiation of the (data or signaling) transmission or reception. The UE may acquire the (first) configuration by the common signaling. The (first) configuration may be (or include) a cell-specific configuration. The (first) configuration may be (or include) a UE-group-specific configuration. The (first) configuration may be (or include) a configuration common for multiple UEs, a group of UEs, and/or a UE group.

The common signaling may be (or include) a broadcast signaling. The common signaling may be received by more than one UE. The common signaling may be received by multiple UEs (or a group of UEs), e.g., in a UE group. The common signaling may be transmitted to more than one UE. The common signaling may be transmitted to multiple UEs (or a group of UEs), e.g. in a UE group. The common signaling may be (or include) system information (specific for Ambient IoT UE(s)). The common signaling may be (or include) a paging (message) (specific for Ambient IoT UE(s)). The common signaling may be (or include) a query (message). The common signaling may be (or include) a Physical Layer (PHY) signaling (e.g., PRDCH, Physical Downlink Control Channel (PDCCH), Downlink Control Information (DCI), Forward Link (FL)/DL command) scheduling/indicating the paging (message) or query (message). The common signaling may be (or include) a PHY signaling (e.g., PRDCH, PDCCH, DCI, FL/DL command) indicating the UE group. The common signaling may be (or include) (any of) RRC signaling (e.g., RRC configuration message), Medium Access Control (MAC) signaling (e.g., MAC Control Element (CE)), Layer 2 signaling, PHY signaling (e.g., PRDCH, PDCCH, DCI, FL/DL command), or Layer 1 signaling, e.g., for ambient IoT. The common signaling may be (or include) an R2D signal/channel, carrier wave (signal) and/or interrogation signal. The common signaling may be used to trigger (or indicate) a transmission (or reception), e.g., of the UE and/or of multiple UEs. The transmission from the UE may be (or include) a backscattering transmission (or reception) or may be generated internally by the UE. The common signaling may be used to provide a power source and/or energy to the UE. The common signaling may be used to initiate a UL transmission of the UE and/or of multiple UEs.

Carrying Via a Dedicated Signaling (e.g., from a Network)

The UE may receive a dedicated signaling including or indicating at least the (first) configuration. The UE may apply the (first) configuration in response to receiving the dedicated signaling including the (first) configuration. The UE may apply the (first) configuration in response to initiation of the (data or signaling) transmission or reception. The UE may acquire the (first) configuration by the dedicated signaling. The (first) configuration may be (or include) a UE-specific configuration. The first configuration may be (or include) a configuration dedicated for a (single) UE.

The dedicated signaling may be (or include) a UE-specific signaling. The dedicated signaling may be (or include) RRC signaling (e.g., RRC configuration message). The dedicated signaling may be (or include) MAC signaling (e.g., MAC CE). The dedicated signaling may be (or include) PHY signaling (e.g., PRDCH, PDCCH, DCI, FL/DL command). The dedicated signaling may be (or include) an R2D signal/channel, carrier wave (signal), and/or interrogation signal. The dedicated signaling may be used to trigger (or indicate) a transmission (or reception) of the UE. The transmission from the UE may be (or include) a backscattering transmission (or reception) or may be generated internally by the UE. The dedicated signaling may be used to provide a power source and/or energy to the UE. The dedicated signaling may be used to trigger (or indicate) a UL transmission of the UE.

### Pre-Configured, Pre-Defined, or Fixed

The UE may apply (or use) a pre-configured (or pre-defined, or fixed) value for the (first) configuration. The UE may apply (or use) a pre-configured (or pre-defined, or fixed) configuration for the (first) configuration. The UE may not receive a signaling including at least the (first) configuration. The UE may apply (or use) the (first) configuration without receiving a signaling including or indicating at least the (first) configuration. The signaling may be a common signaling and/or a dedicated signaling. The UE may apply the pre-configured (or pre-defined, or fixed) value or configuration in response to initiation of the (data or signaling) transmission or reception. The UE may apply the pre-configured (or pre-defined, or fixed) value or configuration, e.g., based on a type of the UE. The UE may apply the pre-configured (or pre-defined, or fixed) value or configuration for performing backscattering transmission (or reception) or for performing the transmission generated internally by the UE. Preferably in certain embodiments, the UE may perform the transmission in response to reception/detection of an R2D signal/channel (or carrier wave (signal)). The pre-configured (or pre-defined, or fixed) value or configuration may be for a Bandwidth Part (BWP) of Ambient IoT.

### Hybrid of the Above

The UE may determine (or derive) the (first) configuration by a hybrid method. The UE may determine (or derive) the (first) configuration by more than one method mentioned above.

The UE may determine (or derive) a first parameter of the (first) configuration by one of the above methods. The UE may determine (or derive) a second parameter of the (first) configuration by another one of the above methods.

In one or more examples, multiple values (or configurations) may be pre-configured (or pre-defined) for the first configuration, and a signaling (e.g., common, dedicated) may be used to indicate the UE which value (or configuration) among the multiple values (or configurations) is applied for the (first) configuration.

In one or more examples, the UE may receive a first part of the (first) configuration by a first signaling (e.g., common signaling) and a second part of the (first) configuration by a second signaling (e.g., dedicated signaling). The UE may apply (the first part and the second part of) the (first) configuration when/after/in response to receiving (both or one of) the first signaling and the second signaling.

In one or more examples, the UE may apply (or use) pre-configured (or pre-defined, or fixed) value(s) for (at least one parameter of) the (first) configuration if (at least) the UE does not receive the signaling (e.g., common, dedicated) (indicating (the at least one parameter of) the (first) configuration). When the UE receives the signaling (e.g., common, dedicated) (indicating (the at least one parameter of) the (first) configuration), the UE may apply (the at least one parameter of) the (first) configuration indicated/provided by the signaling (without applying (or using) pre-configured (or pre-defined, or fixed) value(s) for (the at least one parameter of) the first configuration).

In one or more examples, when the UE detects/receives a first carrier wave (signal) and the UE does not yet receive the signaling (e.g., common, dedicated) during the first carrier wave (signal) duration, the UE may apply (or use) pre-configured (or pre-defined, or fixed) value(s) for performing a first transmission, which is with or associated with the first carrier wave (signal) duration. The first transmission may be a backscattering transmission (or reception) or a transmission generated internally by the UE. When the UE detects/receives a second carrier wave (signal) and the UE receives a first signaling (e.g., common, dedicated) during the second carrier wave (signal) duration, the UE may apply the (first) configuration indicated/provided by the first signaling for performing a second transmission, which is with or associated with the second carrier wave (signal) duration. The second transmission may be a backscattering transmission (or reception) or a transmission generated internally by the UE. When the UE detects/receives a third carrier wave (signal) and the UE receives a second signaling (e.g., common, dedicated) during the third carrier wave (signal) duration, the UE may apply the (first) configuration indicated/provided by the second signaling for performing a third transmission, which is with or associated with the third carrier wave (signal) duration. The third transmission may be a backscattering transmission (or reception) or a transmission generated internally by the UE.

The carrier wave (signal) duration may be a time duration when the UE could receive the carrier wave (signal). The carrier wave (signal) duration may start from when a (new) carrier wave (signal) is started. The carrier wave (signal) duration may end at when the carrier wave (signal) is stopped. The carrier wave (signal) duration may be detected by the UE or be defined/configured by the Network (NW).

In the present invention, a first signaling (e.g., a common signaling) that triggers a transmission and/or a procedure (e.g., a random access procedure) could provide, include, and/or indicate at least one or more resources or configurations for (or to be used by) more than one UE/device (e.g., a group of UEs/devices). The first signaling may be for the more than one UE/device. The first signaling may indicate and/or trigger the more than one UE/device to perform the procedure. The first signaling may provide/include/indicate a configuration related to resources for the more than one UE/device. The first signaling may provide/include/indicate the resources for the more than one UE/device. The resources may be contention-free resources. One resource may correspond to one UE/device. Each of the resources may be dedicated to each of the more than one UE/device. The resources may be the one or more resource. In response to receiving the first signaling, the UE/device may initiate the (e.g., random access) procedure and perform a first transmission (e.g., within/during the procedure) based on the one or more resources or configurations provided, included, or indicated in the first signaling. The UE/device may perform the first transmission based on and/or using a first resource from the one or more resource(s).

In one or more examples, a first UE/device may receive a first signaling of triggering a transmission and/or a procedure (e.g., a (random) access procedure), e.g., from a network node. The first signaling may be a common signaling. The first signaling may be for more than one UE/device. The first signaling may be transmitted to the more than one UE/device. The first signaling may be received by the more than one UE/device. The first signaling may be used to trigger transmission(s) and/or procedure(s) (e.g., random access procedure(s)) for the more than one UE/device. The first signaling may (be used to) indicate the more than one UE/device to trigger the transmission(s) and/or procedure(s) (e.g., random access procedure(s)). The first signaling may be a paging (message) for ambient IoT. The first signaling may indicate (at least) the first UE/device, e.g., by comprising/indicating a device Identification (ID) of the first UE/device and/or a group ID of the first UE/device. The first signaling may include a list of IDs of the more than one UE/device. The first signaling may indicate (at least) more than one resource for the more than one UE/device. The first signaling may indicate an association/mapping between the more than one resource and the more than one UE/device. The first signaling may indicate (at least) a third UE/device, e.g., by comprising/indicating a device ID of the third UE/device and/or a group ID of the third UE/device. The first signaling may not indicate the third UE/device. The more than one UE/device may comprise the first UE/device and/or the third UE/device. The more than one UE/device may be ambient IoT UE(s)/device(s).

In response to receiving the first signaling, the first UE/device may trigger the random access procedure and perform a first transmission of the random access procedure based on a first resource and/or a first configuration provided in the first signaling. The first UE/device may transmit the first transmission to the network node. The first signaling may comprise and/or indicate (at least) the first resource and/or the first configuration (e.g., for the first UE/device). The first resource and/or the first configuration may be derived/determined/selected by the first UE. The first resource and/or the first configuration may be used for, associated with, and/or related to the random access procedure. The first resource and/or the first configuration may be used by, associated with, and/or related to the first UE/device. The first resource and/or the first configuration may be derived/determined/selected based on the order of the first UE in the list of IDs of multiple UEs. The first resource and/or the first configuration may be derived/determined/selected based on at least the ID of the first UE and/or a modulo calculation. The first resource may comprise (at least) a first frequency (domain) resource/occasion(s) (set), and/or a first time (domain) resource/occasion(s) (set). The first resource may be determined based on the first configuration and/or a pre-configuration.

In response to receiving the first signaling, the third UE/device may trigger another random access procedure and perform another first transmission of the other/another random access procedure based on a second resource and/or a second configuration provided in the first signaling. The third UE/device may transmit the another first transmission to the network node. The first signaling may comprise and/or indicate the second resource and/or the second configuration (e.g., for the third UE/device). The second resource and/or the second configuration may be derived/determined/selected by the third UE. The second resource and/or the second configuration may be used for, associated with, and/or related to the another random access procedure. The second resource and/or the second configuration may be used by, associated with, and/or related to the third UE/device. The second resource and/or the second configuration may be derived/determined/selected based on the order of the third UE in the list of IDs of multiple UEs. The second resource and/or the second configuration may be derived/determined/selected based on at least the ID of the third UE and/or a modulo calculation. The second resource may comprise (at least) a second frequency (domain) resource/occasion(s) (set), and/or a second time (domain) resource/occasion(s) (set). The second resource may be determined based on the second configuration and/or another pre-configuration.

Throughout the present disclosure, when a UE determines a configuration, the UE may require, receive, derive, acquire, determine, store, apply, and/or use the configuration. The configuration (e.g., the first configuration) may be (or include or indicate) one or more parameters of the following:

### Configuration Related to BWP(s) (of a Cell)

The configuration may be (or include) any of: initialUplinkBWP, initialDownlinkBWP. BWP. subcarrierSpacing, BWP-Downlink, BWP-DownInkCommon, BWP-DownlinkDedicated, BWP-Id. BWP-Uplink, BWP-UplinkCommon, BWP-UplinkDedicated, transmission bandwidth configuration, occupation bandwidth configuration, channel bandwidth configuration, and/or system bandwidth configuration.

The UE may be configured with one or more (initial) BWPs of a cell. Alternatively and/or additionally in certain embodiments, a cell may include or indicate more than one (initial) BWP (for ambient IoT). The UE may be configured with different initial BWPs in different bands and/or frequencies of a cell. The UE may be configured with multiple BWPs with spectrum deployment in-band to an NR cell. The BWP may be a UL BWP.

The BWP (in above or below) may be changed/represented/replaced by a frequency (sub-) band or frequency resource set, system bandwidth/band, and/or transmission bandwidth/band. The BWP, bandwidth, and/or band may be for R2D and/or D2R.

When the UE receives/detects PRDCH, an R2D signal/channel or carrier wave (signal), the UE may derive/determine a (initial) BWP, a (initial) frequency (sub-) band, or (initial) frequency resource set based on at least the frequency (e.g., DL carrier or DL frequency band), e.g., the frequency of a received/detected PRDCH, R2D signal/channel, or carrier wave (signal). Preferably in certain embodiments, the UE may derive/determine a (initial) BWP, a (initial) frequency (sub-) band, or (initial) frequency resource set based on at least the BWP, frequency (sub-) band, or frequency resource set information provided from the network.

The UE may receive the configuration related to BWP(s) of a cell via a first BWP of the cell. The first BWP may or may not be one of the BWP(s). The UE may perform the (data or signaling) transmission or reception via a second BWP of the BWP(s) of the cell. The first BWP may be different from the second BWP.

### Configuration Related to Paging

The configuration may be (or include) any of: a paging cycle configuration, paging frame configuration, paging occasion configuration, PCCH-config, and/or (default) PagingCycle.

The UE may be configured with at least a configuration related to paging. The UE may be pre-configured with at least a configuration related to paging. The UE may use (or apply) a pre-configured (or fixed) value for the configuration. The UE may not require the configuration related to paging. The UE may not require the network to provide the configuration related to paging.

### Configuration Related to System Information

The configuration may be (or include) any of: a system information scheduling configuration, system information modification configuration, system information request configuration, BCCH-config, SI-SchedulingInfo, and/or SI-RequestConfig.

The UE may be configured with at least a configuration related to system information. The UE may be pre-configured with at least a configuration related to system information. The UE may use (or apply) a pre-configured (or fixed) value for the configuration. The UE may not require the configuration related to system information. The UE may not require the network to provide the configuration related to system information.

### Configuration Related to (Data) Transmission or Reception

The configuration may be (or include) any of: PUSCH-Config, PUSCH-ConfigCommon, PUSCH-ServingCellConfig. PDSCH-Config. PDSCH-ConfigCommon, PDSCH-ServingCellConfig, PRDCH configuration, PDRCH configuration, Semi-Persistent Scheduling (SPS) configuration, configured grant configuration, and/or Hybrid Automatic Repeat Request (HARQ) configuration, transmission bandwidth configuration, occupation bandwidth configuration, channel bandwidth configuration, and/or system bandwidth configuration.

The UE may be configured with at least a configuration related to (data) transmission or reception. The UE may be pre-configured with at least the configuration. The UE may use (or apply) a pre-configured (or fixed) value for the configuration. The UE may not require the configuration. The UE may not require the network to provide the configuration.

### Configuration Related to Downlink Control Signaling

The configuration may be (or include) any of: PDCCH configuration, Control Resource Set (CORESET) configuration, search space configuration, PDCCH-Config, PDCCH-ConfigCommon, PDCCH-ConfigSIBI, PDCCH-ServingCellConfig. ControlResourceSet, ControlResourceSetId, ControlResourceSetZero, SearchSpace, SearchSpaceId, and/or SearchSpaceZero, PRDCH configuration.

The UE may be configured with one (or more) PDCCH configuration, CORESET configuration, and/or search space configuration. The UE may not be allowed to configure more than one PDCCH configuration, CORESET configuration, and/or search space configuration.

The UE may be pre-configured with one (or more) PDCCH configuration, CORESET configuration, and/or search space configuration. The UE may use (or apply) a pre-configured (or fixed) value for the configuration. The UE may not require the configuration. The UE may not require the network to provide the configuration.

The UE may determine or derive the one (or more) PDCCH configuration, CORESET configuration, and/or search space configuration based on a detected carrier wave (signal). The UE may determine or derive the time-frequency resources for monitoring/receiving DL signaling (e.g., DCI, PRDCH, PDCCH, FL/DL command) based on (time and/or frequency resources of) the detected carrier wave (signal).

### Threshold(s) for Power Measurement (or Signal Power Strength)

The configuration may be one or more thresholds for power measurement of a signal or for signal power strength. The signal may be a Sounding Reference Signal (SRS). The signal may be a Synchronization Signal (SS)/PBCH Block (SSB) and/or a Channel State Information Reference Signal (CSI-RS). The power measurement may be Reference Signal Received Power (RSRP), Reference Signal Received Quality (RSRQ), and/or Signal to Interference plus Noise Ratio (SINR).

The UE may select a UL resource (pool) based on the one or more thresholds and/or the power measurement. For example, the UE may select a UL resource (pool) based on different power measurements of the signal. The UE may select a UL resource (pool) if at least a threshold (e.g., for RSRP) is fulfilled. The UE may not select a UL resource (pool) if at least the threshold is not fulfilled. The UE may select a UL resource (pool) once the threshold is fulfilled. The UE may not select a UL resource (pool) until the threshold is fulfilled. For example, the UE may select a UL resource (pool) if at least the power measurement is larger than or equal to a threshold (e.g., for RSRP). The UE may not select the UL resource (pool) if at least the power measurement is smaller than or equal to the threshold. The UE may select the UL resource (pool) once the power measurement is larger than or equal to the threshold. The UE may select a first UL resource (pool) if at least the power measurement is larger than or equal to a first threshold (e.g., for RSRP) and is smaller than a second threshold (e.g., for RSRP). The UE may select a second UL resource (pool) if at least the power measurement is smaller than the first threshold (e.g., for RSRP). The UE may select a third UL resource (pool) if at least the power measurement is larger than the second threshold (e.g., for RSRP).

The UE may select a repetition number (of a (UL) transmission) based on the one or more thresholds and/or the power measurement. Each of the (configured or predefined) repetition numbers may be associated with a threshold. For example, the UE may select a repetition number based on different power measurements of the signal. The UE may select a repetition number if at least a threshold (e.g., for RSRP) is fulfilled. The UE may not select a repetition number if at least the threshold is not fulfilled. The UE may select a repetition number once the threshold is fulfilled. The UE may not select a repetition number until the threshold is fulfilled. For example, the UE may select a repetition number if at least the power measurement is larger than or equal to a threshold (e.g., for RSRP). The UE may not select the repetition number if at least the power measurement is smaller than or equal to the threshold. The UE may select the repetition number once the power measurement is larger than or equal to the threshold. The UE may select a first repetition number if at least the power measurement is larger than or equal to a first threshold (e.g., for RSRP) and is smaller than a second threshold (e.g., for RSRP). The UE may select a second repetition number if at least the power measurement is smaller than the first threshold (e.g., for RSRP). The UE may select a third repetition number if at least the power measurement is larger than the second threshold (e.g., for RSRP). For another example, the UE may select a repetition number if at least the power measurement is smaller than or equal to a threshold (e.g., for RSRP). The UE may not select the repetition number if at least the power measurement is larger than or equal to the threshold. The UE may select the repetition number once the power measurement is smaller than or equal to the threshold. The UE may select a first repetition number if at least the power measurement is smaller than or equal to a first threshold (e.g., for RSRP) and is larger than a second threshold (e.g., for RSRP). The UE may select a second repetition number if at least the power measurement is larger than the first threshold (e.g., for RSRP). The UE may select a third repetition number if at least the power measurement is smaller than the second threshold (e.g., for RSRP). Preferably in certain embodiments, if the repetition number is one, the UE may perform one transmission without repetition. Preferably and/or alternatively in certain embodiments, if the repetition number is one, the UE may perform one repetition in addition to the first/initial transmission.

The UE may determine whether to perform (or initiate) (a procedure of) a (data or signaling) transmission or reception based on the one or more thresholds and/or the power measurement. For example, the UE may determine whether to perform (or initiate) (a procedure of) a (data or signaling) transmission or reception based on different power measurements of the signal. The UE may decide to perform (or initiate) (a procedure of) a (data or signaling) transmission or reception if at least a threshold (e.g., for RSRP) is fulfilled. The UE may decide not to perform (or initiate) (a procedure of) a (data or signaling) transmission or reception if at least the threshold is not fulfilled. The UE may decide to perform (or initiate) (a procedure of) a (data or signaling) transmission or reception once the threshold is fulfilled. The UE may decide not to perform (or initiate) (a procedure of) a (data or signaling) transmission or reception until the threshold is fulfilled. For example, the UE may decide to perform (or initiate) (a procedure of) a (data or signaling) transmission or reception if at least the power measurement is larger than or equal to a threshold (e.g., for RSRP). The UE may decide not to perform (or initiate) (the procedure of) the (data or signaling) transmission or reception if at least the power measurement is smaller than or equal to the threshold. The UE may decide to perform (or initiate) (the procedure of) the (data or signaling) transmission or reception once the power measurement is larger than or equal to the threshold.

The UE may be pre-configured with at least the configuration. The UE may use (or apply) a pre-configured (or fixed) value for the configuration. The UE may require the configuration. The UE may acquire the configuration from a common signaling. The UE may require the network to provide the configuration.

### Threshold(s) for Power in Energy Storage

The configuration may be one or more thresholds for the amount of the UE's (remaining) battery power/stored power/available power/power level (in the UE's energy storage).

The UE may select a UL resource (pool) based on a different amount of the UE's battery power/stored power/available power/power level of the UE. For example, the UE may select a UL resource (pool) if at least a threshold (for the amount of the UE's battery power/stored power/available power/power level) is fulfilled. The UE may not select a UL resource (pool) if at least the threshold is not fulfilled. The UE may select a UL resource (pool) once the threshold is fulfilled. The UE may not select a UL resource (pool) until the threshold is fulfilled.

The UE may select a repetition number based on a different amount of the UE's battery power/stored power/available power/power level of the UE. For example, the UE may select a repetition number if at least a threshold (for the amount of the UE's battery power/stored power/available power/power level) is fulfilled. The UE may not select a repetition number if at least the threshold is not fulfilled. The UE may select a repetition number once the threshold is fulfilled. The UE may not select a repetition number until the threshold is fulfilled.

The UE may determine whether to perform (or initiate) (a procedure of) a (data or signaling) transmission or reception based on the one or more thresholds and/or the battery power/stored power/available power/power level of the UE. For example, the UE may determine whether to perform (or initiate) (a procedure of) a (data or signaling) transmission or reception based on a different amount of the UE's battery power/stored power/available power/power level of the UE. The UE may decide to perform (or initiate) (a procedure of) a (data or signaling) transmission or reception if at least a threshold (for the amount of the UE's battery power/stored power/available power/power level) is fulfilled. The UE may decide not to perform (or initiate) (a procedure of) a (data or signaling) transmission or reception if at least the threshold is not fulfilled. The UE may decide to perform (or initiate) (a procedure of) a (data or signaling) transmission or reception once the threshold is fulfilled. The UE may decide not to perform (or initiate) (a procedure of) a (data or signaling) transmission or reception until the threshold is fulfilled. For example, the UE may decide to perform (or initiate) (a procedure of) a (data or signaling) transmission or reception if at least the battery power/stored power/available power/power level of the UE is larger than or equal to a threshold (e.g., for RSRP). The UE may decide not to perform (or initiate) (the procedure of) the (data or signaling) transmission or reception if at least the battery power/stored power/available power/power level of the UE is smaller than or equal to the threshold. The UE may decide to perform (or initiate) (the procedure of) the (data or signaling) transmission or reception once the battery power/stored power/available power/power level of the UE is larger than or equal to the threshold.

The UE may be pre-configured with at least the configuration. The UE may use (or apply) a pre-configured (or fixed) value for the configuration. The UE may require the configuration. The UE may acquire the configuration from a common signaling. The UE may require the network to provide the configuration.

(Possible) Repetition Number(s) (for a (UL) Transmission Performed by the UE) The configuration may be one or more repetition numbers (for a (UL) transmission performed by the UE). The repetition number is related to a number of retransmission(s) of the transmission autonomously performed by the UE. For example, when the repetition number is 4, the UE autonomously performs 3 (or 4) retransmissions of the transmission in addition to the transmission. For example, the UE may perform the UL transmission based on the repetition number. The repetition number may correspond to the number of transmission(s) of a Transport Block (TB) for UL transmission. Preferably in certain embodiments, the autonomous retransmissions may mean retransmissions without basing them on a HARQ-Acknowledgement (ACK) from a network or intermediate node. The autonomous retransmissions may mean blind retransmissions.

The UE may be pre-configured with at least the configuration. The UE may use (or apply) a pre-configured (or fixed) value for the configuration. The UE may require the configuration. The UE may acquire the configuration from a common signaling. The UE may require the network to provide the configuration.

### (Possible) Repetition Pattern(s) (for a (UL) Transmission Performed by the UE)

The configuration may be one or more repetition patterns. The repetition pattern is related to the timing of retransmission(s) of the transmission autonomously performed by the UE. The repetition pattern may indicate when the UE performs a transmission, a retransmission, or a repetition, e.g., in which time occasion(s). For example, the UE may perform UL transmission based on the pattern(s) of repetition. The pattern(s) of repetition may correspond to the time occasion(s) of each transmission of a TB for the UL transmission. The time occasion(s) (e.g., symbol(s), slot(s), subframe(s), and/or frame(s)) may be consecutive. The time occasion(s) (e.g., symbol(s), slot(s), subframe(s), and/or frame(s)) may not be consecutive. The repetition pattern may be represented by a bitmap. A bit in the bitmap may correspond to a time occasion. The bit set to 1 may represent that the UE performs a transmission, a retransmission, or a repetition in the corresponding time occasion. The bit set to 0 may represent that the UE does not perform a transmission, a retransmission, or a repetition in the corresponding time occasion. For example, if the repetition pattern is {11001100}, the UE may perform the UL (re) transmissions in a time occasion or Transmission Time Interval (TTI) n, (n+1), (n+4), (n+5), and/or the UE may not perform the UL (re) transmissions in the time occasion or TTI (n+2), (n+3), (n+6), (n+7). Preferably and/or alternatively in certain embodiments, the repetition pattern may be determined based on the time pattern of a radio resource pool, wherein the UE performs the UL (re) transmissions within the same radio resource pool. The UE may not perform the UL (re) transmission in resources outside the radio resource pool. For example, if the time pattern of the radio resource pool comprises the time occasion or TTI n, (n+1), (n+4), (n+5) and does not comprise the time occasion or TTI (n+2), (n+3), (n+6), (n+7). The UE may perform the UL (re) transmissions in the time occasion or TTI n, (n+1), (n+4), (n+5), and/or the UE may not perform the UL (re) transmissions in the time occasion or TTI (n+2), (n+3), (n+6), (n+7). In other words, the UE may perform the UL (re) transmissions in consecutive (logical) time occasions or TTIs of the radio resource pool. While the UE may perform the UL (re) transmissions in non-consecutive (physical) time occasions or TTIs.

The UE may be pre-configured with at least the configuration. The UE may use (or apply) a pre-configured (or fixed) value for the configuration. The UE may require the configuration. The UE may acquire the configuration from a common signaling. The UE may require the network to provide the configuration.

### Configuration Related to Time, Time Duration, or Timer

The configuration may be one or more timers. The configuration may be one or more time durations. The timer may be a validity timer. The timer may be a failure (detection) timer. The timer may be an inactivity timer. The timer may be an on duration timer. The timer may be a transmission timer. The timer and/or time duration may represent a time duration when a (data or signaling) transmission or reception is or could be ongoing.

The UE may detect a failure of (a procedure of) a (data or signaling) transmission or reception based on a timer (of the one or more timers) or a time duration (of the one or more time durations). For example, the UE may use a timer to detect failure. The timer may be started at the beginning of a (UL) procedure. The beginning of the (UL) procedure may be the first time that any radio resource is used/applied by the UE. The timer may be restarted upon a (data or signaling) transmission. The timer may be restarted upon receiving a (new) R2D signal/channel (or carrier wave (signal)). The (UL) procedure may be considered failed (or not successful) upon the expiry/expiration of the timer. The (UL) procedure may not be considered failed (or not successful) when the timer is running.

The UE may detect a success of (a procedure of) a (data or signaling) transmission or reception based on a timer (of the one or more timers) or a time duration (of the one or more time durations). For example, the UE may use a timer to determine whether a (single) (UL) transmission is successful. The timer may be started upon a (data or signaling) transmission. The timer may be restarted upon the (data or signaling) transmission. The (UL) transmission may be considered successful upon the expiry of the timer. The (UL) transmission may not be considered successful when the timer is running.

The UE may stop (a procedure of) a (data or signaling) transmission or reception based on a timer (of the one or more timers) or a time duration (of the one or more time durations). For example, the UE may use a timer to stop a (UL) procedure. The timer may be started at the beginning of a (UL) procedure. The beginning of the (UL) procedure may be the first time that any radio resource is used/applied by the UE. The (UL) procedure may continue when the timer is running. The (UL) procedure may not continue upon the expiry of the timer.

The UE may determine or derive the end of the R2D signal/channel (or carrier wave (signal)) based on a timer (of the one or more timers) or a time duration (of the one or more time durations). For example, the UE may use a timer to determine the duration of a (new) R2D signal/channel (or carrier wave (signal)). The timer may be started when the R2D signal/channel (or carrier wave (signal)) starts. The timer may expire when the R2D signal/channel (or carrier wave (signal)) stops. The UE may consider the R2D signal/channel (or carrier wave (signal)) ended upon (or in response to) the timer expiry.

The UE may determine to perform a retransmission of a (data or signaling) transmission based on a timer (of the one or more timers) or a time duration (of the one or more time durations). For example, the UE may perform a retransmission of a (data or signaling) transmission in response to expiry of the timer.

The UE may be pre-configured with at least the configuration. The UE may use (or apply) a pre-configured (or fixed) value for the configuration. The UE may require the configuration. The UE may acquire the configuration from a common signaling. The UE may require the network to provide the configuration.

### Periodicity(Ies) of Radio Resource

The radio resource for UL transmission may be periodic. The radio resource for UL transmission may be aperiodic. The configuration may be the periodicity of a periodic radio resource. For example, a periodic radio resource may be provided upon the periodicity from the last existing periodic radio resource. A periodic radio resource may not be provided before the periodicity from the last existing periodic radio resource.

The UE may be pre-configured with at least the configuration. The UE may use (or apply) a pre-configured (or fixed) value for the configuration. The UE may require the configuration. The UE may acquire the configuration from a common signaling. The UE may require the network to provide the configuration.

### UE's ID(s)

A UE may be assigned a first UE ID. The UE may be predefined or (pre-) configured (e.g., by the UE) the first UE ID. The UE may be configured or indicated (e.g., by the NW) the first UE ID. The UE may calculate, select, derive, or determine the first UE ID by itself. The UE ID may be a temporary ID. The UE ID may be a random number, e.g., generated by the UE.

A UE may be assigned a second UE ID (e.g., Radio Network Temporary Identifier (RNTI)). The UE may be predefined or (pre-) configured (e.g., by the UE) the second UE ID. The UE may be configured or indicated (e.g., by the NW) the second UE ID. The UE may calculate, select, derive, or determine the second UE ID by itself. A DL command, a PRDCH or a PDCCH for scheduling a UL grant or DL assignment may indicate the second UE ID. A DL command, a PRDCH or a PDCCH for scheduling UL grant or DL assignment may be scrambled by the second UE ID. A source of a transmission (from the UE) or a destination of a reception (to the UE) may be indicated by (complete or part of) the first UE ID or the second UE ID.

The second UE ID may be determined or calculated based on a radio resource selected/determined by the UE. Alternatively and/or additionally in certain embodiments, the second UE ID may be determined or calculated based on the first UE ID. Alternatively and/or additionally in certain embodiments, the second UE

ID may be part of the first UE ID. Alternatively and/or additionally in certain embodiments, the second UE ID may be determined or calculated based on the order of the UE indicated in a paging message (e.g., PagingRecordList or PagingGroupList). Alternatively in certain embodiments, the second UE ID may be a fixed value.

The configuration may be an ID dedicated to a UE. For example, the dedicated ID may be used to identify a UE. The UE identified by the dedicated ID may be scheduled (e.g., by the NW) dynamically. The UE not identified by the dedicated ID may not be scheduled (e.g., by the NW) dynamically.

The UE may be pre-configured with at least the configuration. The UE may use (or apply) a pre-configured (or fixed) value for the configuration. The UE may be configured or indicated by (e.g., by the NW) the configuration. The UE may calculate, select, derive, or determine the configuration by itself. The dedicated ID may be calculated/determined based on the radio resources selected/determined by the UE. The dedicated ID may be calculated/determined based on an ID associated with the UE. The dedicated ID may be calculated/determined based on the order of the UE indicated in the paging message (e.g., PagingRecordList or PagingGroupList). The dedicated ID may be fixed for scrambling.

### UE Group's ID(s)

There may be multiple UE groups. The configuration may be a UE group ID. A UE may be assigned or associated with a UE group. The UE may be predefined or (pre-) configured (e.g., by the UE) with the UE group. The UE may be configured or indicated (e.g., by the NW) with the UE group. The UE may receive a group ID and/or a value to derive/determine the group ID via query, paging, System Information Block (SIB), PRDCH, and/or PDCCH. The UE may receive a group ID and/or a value to derive/determine the group ID during registration or authentication. The UE may derive or determine the group ID based on the first UE ID or the second UE ID.

### Time Duration(s) for a UE Group

The configuration may be one or more time durations. A time duration may be associated with/correspond to a UE group (of the UE). Different UE groups may be associated with/correspond to different time durations. For example, a UE may acquire a radio resource in the time duration if (at least) the time duration is associated with/corresponds to the UE group of the UE. The UE may be allowed to perform or initiate (a procedure of) a (data or signaling) transmission or reception in a first time duration if (at least) the first time duration is associated with/corresponds to the UE group of the UE. A UE may not acquire a radio resource during the time duration if (at least) the time duration is not associated with/does not correspond to the UE group of the UE. The UE may not be allowed to perform or initiate (a procedure of) a (data or signaling) transmission or reception in a second time duration if (at least) the second time duration is not associated with/correspond to the UE group of the UE.

The UE may be pre-configured with at least the configuration. The UE may use (or apply) a pre-configured (or fixed) value for the configuration. The UE may require the configuration. The UE may acquire the configuration from a common signaling. The UE may require the network to provide the configuration.

Association Between Radio Resource (Pool) and UE ID and/or UE Group Associated with the UE(s)

The configuration may be an indicator. The indicator may be used to indicate the radio resource (pool). The indicator may be associated with a UE ID(s) and/or UE group ID(s).

For example, the UE may select the radio resource (pool) indicated by an indicator if (at least) the UE ID of the UE is associated with the indicator. The UE may select the radio resource (pool) indicated by an indicator if (at least) the UE group ID of the UE is associated with the indicator. The UE may not select the radio resource (pool) indicated by an indicator if (at least) the UE ID of the UE is not associated with the indicator. The UE may not select the radio resource (pool) indicated by an indicator if (at least) the UE group ID of the UE is not associated with the indicator.

The UE may determine/derive/select a radio resource (pool) based on (part of) its UE ID or UE group ID.

The UE may be pre-configured with at least the configuration. The UE may use (or apply) a pre-configured (or fixed) value for the configuration. The UE may require the configuration. The UE may acquire the configuration from a common signaling. The UE may require the network to provide the configuration.

### Association Between Radio Resource (Pool) and Order of UE Indicated in a Paging Message

The configuration may be an indicator. The indicator may be used to indicate the radio resource (pool). The indicator may be associated with the order of a UE indicated or specified in the paging message.

For example, the UE may select the radio resource (pool) indicated by an indicator if (at least) the order of the UE indicated or specified in the paging message is associated with the indicator. The UE may not select the radio resource (pool) indicated by an indicator if (at least) the order of the UE specified in the paging message is not associated with the indicator.

The paging message may indicate association between a radio resource (pool) and one or more UEs. The paging message may indicate association between a radio resource (pool) and one or more UE IDs.

The UE may be pre-configured with at least the configuration. The UE may use (or apply) a pre-configured (or fixed) value for the configuration. The UE may require the configuration. The UE may acquire the configuration from a common signaling. The UE may require the network to provide the configuration.

### Configuration for Sensing Whether a Radio Resource is Used

The configuration may be a time duration. Different UE groups may be associated with/correspond to different time durations. Different UE groups may be associated with/correspond to the same time duration. For example, the UE may perform sensing in the time duration. The UE may not perform sensing outside the time duration.

The UE may be pre-configured with at least the configuration. The UE may use (or apply) a pre-configured (or fixed) value for the configuration. The UE may require the configuration. The UE may acquire the configuration from a common signaling. The UE may require the network to provide the configuration.

The configuration may be a threshold for a signal power strength. The signal can be an SRS. The signal can be an SSB. The power measurement may be RSRP, RSRQ, and/or SINR. For example, the UE may determine whether the sensed radio resource is occupied based on a signal power strength. The UE may consider the sensed radio resource vacant if at least the threshold (e.g., for RSRP) is fulfilled. The UE may consider the sensed radio resource occupied if at least the threshold is not fulfilled. The UE may consider the sensed radio resource vacant once the threshold is fulfilled. The UE may consider the sensed radio resource occupied until the threshold is fulfilled.

The UE may be pre-configured with at least the configuration. The UE may use (or apply) a pre-configured (or fixed) value for the configuration. The UE may require the configuration. The UE may acquire the configuration from a common signaling. The UE may require the network to provide the configuration.

### Miscellaneous

The configuration may be (or include) any of: a configuration related to SSB (or CSI-RS), configuration related to downlink control signaling, configuration related to small data transmission, configuration related to uplink control information, PUCCH-ConfigCommon, scheduling request configuration, SRS configuration, Buffer Status Report (BSR) configuration, Power Headroom Report (PHR) configuration, Discontinuous Reception (DRX) configuration, MAC-CellGroupConfig and/or radio link monitoring configuration, measurement configuration, measurement gap configuration, measurement object configuration, and/or measurement report configuration.

The UE may be configured with at least the configuration. The UE may be pre-configured with at least the configuration. The UE may use (or apply) a pre-configured (or fixed) value for the configuration. The UE may not require the configuration. The UE may not require the network to provide the configuration.

Alternatively and/or additionally in certain embodiments, the configuration (e.g., the first configuration) may be (or include) one or more parameters related to a radio resource to be used for a (data or signaling) transmission or reception. The radio resource could be contention-based or contention free. The configuration (e.g., the first configuration) may be (or include or indicate) one or more parameters of the following:

### Pool(s) of Radio Resource

A first UE may determine (or derive) at least a configuration (e.g., a first configuration). The configuration (e.g., the first configuration) may be associated with (and/or correspond to) one or more radio resource pool(s). Multiple radio resource pools may be provided (for different configurations). A radio resource pool may include a set or multiple of radio resource(s) (in time and/or frequency domain) for UL transmission(s). The first UE may select/determine a radio resource pool corresponding to the configuration (e.g., the first configuration). The first UE may acquire/determine the UL transmission resource from the selected/determined radio resource pool. The radio resource for the UL transmission may be provided periodically. The radio resource for the UL transmission may be provided for a single transmission (or aperiodically, or one-shot) (with repetition). The first UE may perform a backscattering transmission on the radio resource for UL transmission. The first UE may perform the UL transmission (internally) by itself on the radio resource for UL transmission.

Preferably and/or alternatively in certain embodiments, the first UE may determine/derive a radio resource pool based on a received DL signaling (e.g., DCI, PRDCH, PDCCH, FL/DL command). The DL signaling may comprise a configuration of the radio resource pool. The first UE may perform the UL transmission within one radio resource pool in response to the DL signaling indicating the UE or the corresponding UE ID or associated UE group ID. The network or intermediate node may perform one or multiple DL signalings for indicating the (same) one radio resource pool. When the first UE receives the DL signaling and when the DL signaling indicates the UE being able to use the radio resource pool, the first UE may perform the UL transmission(s) within the one radio resource pool.

Different radio resource pools may be associated with different repetition numbers, different repetition patterns, different BWPs, different UE types, different UE groups, different sizes of UL grants, different types of data/signaling, and/or different power levels.

### Time Domain Allocation(s) of the Radio Resource

The configuration may include single time domain allocation of the radio resource. The configuration may include multiple time domain allocations of the radio resource. The configuration may include none of the time domain allocation of the radio resource.

Different time domain allocations may be associated with different repetition numbers, different repetition patterns, different resource pools, different BWPs, different UE types, different UE groups, different sizes of UL grants, different types of data/signaling, and/or different power levels.

### Frequency Domain Allocation(s) of the Radio Resource

The configuration may include single frequency domain allocation of the radio resource. The configuration may include multiple frequency domain allocations of the radio resource. The configuration may include none of the frequency domain allocation of the radio resource.

Different frequency domain allocations may be associated with different repetition numbers, different repetition patterns, different resource pools, different BWPs, different UE types, different UE groups, different sizes of UL grants, different types of data/signaling, and/or different power levels.

Bwp(s) Associated with the Radio Resource

The configuration may include a single BWP associated with the radio resource. The configuration may include multiple BWPs associated with the radio resource. The configuration may include none of the BWPs associated with the radio resource.

Different BWPs may be associated with different repetition numbers, different BWPs, different UE types, different UE groups, different sizes of UL grants, different types of data/signaling, and/or different power levels.

One or more resource selection step(s) may be performed (by the UE or network) based on the first factor, e.g., for (data and/or signaling) transmission or reception, e.g., based on a first factor and/or a second factor. The resource selection step(s) may comprise radio resource pool selection, radio resource selection, and/or radio resource allocation selection. The UE may select a radio resource pool in the resource selection step(s). The UE may select a radio resource in the resource selection step(s). The UE may select a radio resource from the selected radio resource pool. The UE may select a radio resource based on the selected radio resource pool. The UE may select a radio resource allocation in the resource selection step(s). The UE may select a radio resource allocation based on the selected radio resource.

The UE may perform a first resource selection step. The UE may perform a second resource selection step based on the first resource selection step. The UE may perform the second resource selection step not based on the first resource selection step. The first resource selection step and the second resource selection step may be performed individually. The first resource selection step and the second resource selection step may have association. The first resource selection step and the second resource selection step may be performed based on the same factor (e.g., first factor, second factor, third factor). The first resource selection step and the second resource selection step may be performed based on different factors (e.g., first factor, second factor, third factor). The first resource selection step and the second resource selection step may be different resource selection steps.

Throughout the present disclosure, the radio resource may be used for (data/signaling) transmission or reception. The radio resource may be used for one (data/signaling) transmission or reception. The radio resource may be used for multiple (data/signaling) transmissions or receptions, e.g., within a period. The radio resource may be periodically available for the UE.

Throughout the present disclosure, the “Random Access (RA) resource(s)/configuration(s)”, “UL resource(s)/configuration(s)” and/or “resource(s)/configuration(s)” may be, be replaced by, and/or be referred to resource(s)/configuration(s) for D2R transmission (e.g., as described above). The resource(s) and/or configuration(s) may comprise PDRCH (transmission) resource(s), occasion(s), channel resource(s), frequency resources and/or (sub-) band(s), e.g., for D2R transmission. The resource(s) and/or configuration(s) may comprise a parameter, random number, group number, and/or assistance information, e.g., for D2R transmission.

When there are multiple pools of radio resources, selecting at least one resource pool from the multiple resource pools (for UL transmission) may be performed (by the UE or network) based on a first factor. If no resource pool can be selected (based on the first factor), the UE may not perform a UL transmission (or consider the condition of initiating the UL transmission not fulfilled). If no resource pool can be selected based on the first factor, the UE may select a resource pool not based on the first factor, e.g., based on another factor. If no resource pool can be selected based on the first factor, the UE may use a default resource pool.

When there are multiple radio resources in a pool of radio resources, selecting at least one radio resource from the multiple radio resources (for UL transmission) may be performed (by the UE or network) based on a second factor. If no radio resource can be selected (based on the second factor), the UE may not perform a UL transmission (or consider the condition of initiating the UL transmission not fulfilled). If no radio resource can be selected based on the second factor, the UE may select a radio resource not based on the second factor, e.g., based on another factor. If no radio resource can be selected based on the second factor, the UE may use a default radio resource.

When there are multiple (or none of) time domain allocations of the radio resource, selecting at least one time domain allocation (from the multiple time domain allocations) (for UL transmission) may be performed (by the UE or network) based on a third factor. If no time domain allocation can be selected (based on the third factor), the UE may not perform a UL transmission (or consider the condition of initiating the UL transmission not fulfilled). If no time domain allocation can be selected based on the third factor, the UE may select a time domain allocation not based on the third factor, e.g., based on another factor. If no time domain allocation can be selected based on the third factor, the UE may use a default time domain allocation.

When there are multiple (or none of) frequency domain allocations of the radio resource, selecting at least one frequency domain allocation (from the multiple frequency domain allocations) (for UL transmission) may be performed (by the UE or network) based on a third factor. If no frequency domain allocation can be selected (based on the third factor), the UE may not perform a UL transmission (or consider the condition of initiating the UL transmission not fulfilled). If no frequency domain allocation can be selected based on the third factor, the UE may select a frequency domain allocation not based on the third factor, e.g., based on another factor. If no frequency domain allocation can be selected based on the third factor, the UE may use a default frequency domain allocation.

When there are multiple (or none of) BWPs associated with the radio resource, selecting at least one BWP (from the multiple BWP) (for UL transmission) may be performed (by the UE or network) based on a third factor. If no BWP can be selected (based on the third factor), the UE may not perform a UL transmission (or consider the condition of initiating the UL transmission not fulfilled). If no BWP can be selected based on the third factor, the UE may select a BWP not based on the third factor, e.g., based on another factor. If no BWP can be selected based on the third factor, the UE may use a default BWP.

The first factor could be the same as the second factor. Alternatively in certain embodiments, the first factor could be partially the same as the second factor. Alternatively in certain embodiments, the first factor could be (completely) different from the second factor.

The first factor could be the same as the third factor. Alternatively in certain embodiments, the first factor could be partially the same as the third factor. Alternatively in certain embodiments, the first factor could be (completely) different from the third factor.

The third factor could be the same as the second factor. Alternatively in certain embodiments, the third factor could be partially the same as the second factor. Alternatively in certain embodiments, the third factor could be (completely) different from the second factor.

The first factor, the second factor, and/or the third factor may be or include one or more of the following:

### Ue Type

There may be two or more types of (Ambient IoT) UEs. The UE types may be differentiated by at least peak power consumption, energy storage, method to perform UL transmission, power level, and/or device size. Preferably in certain embodiments, the method to perform UL transmission may be generated internally by the device/UE or be backscattered on the R2D signal/channel (or carrier wave (signal)) provided externally.

For example, a first type UE may be a device A or device B, e.g., as considered in [2] 3GPP TR 38.848 V18.0.0 (2023-09). The first type UE may have peak power consumption for about 1 W. The first type UE may have (or be equipped with) a battery or energy storage. The first type UE may not have (or be equipped with) DL/UL amplification. The first type UE may be a passive or semi-passive device. The first type UE may generate a UL transmission by backscattering. The first type UE may perform a backscattering transmission. The first type UE may not be able to generate a UL transmission (internally) by itself. The first type UE may not have the capability to generate a signal without backscattering. For example, the first UE may be the first type UE.

For example, a second type UE may be a device C, e.g., as considered in [2] 3GPP TR 38.848 V18.0.0 (2023-09). The second type UE may have peak power consumption for less than a few hundred ρW. The second type UE may have (or be equipped with) a battery or energy storage. The second type UE may have (or be equipped with) DL/UL amplification. The second type UE may be an active device. The second type UE may generate a UL transmission by backscattering. The second type UE may perform a backscattering transmission. The second type UE may be able to generate a UL transmission (internally) by itself. The second type UE may have the capability to generate a signal without backscattering. For example, the first UE may be the second type UE.

For example, a third type UE may have (or be equipped with) a battery or energy storage. The third type UE may have (or be equipped with) DL/UL amplification. The third type UE may be an active device. The third type UE may generate a UL transmission by backscattering. The third type UE may perform a backscattering transmission. The third type UE may be able to generate a UL transmission (internally) by itself. The third type UE may have the capability to generate a signal without backscattering.

### Power Level

The power level may comprise any one or more of the following embodiments. The UE may utilize a same or different power level embodiment(s) for a different radio resource pool selection and/or radio resource selection (e.g., radio resource selection in time domain and/or frequency domain). There may be one or more thresholds for the power level. The power level may be determined by a threshold(s). The threshold(s) for the power level may be configured by the network or be derived by the UE. The threshold(s) for the power level may be determined based on the following embodiments.

The power level may be a received power or power measurement of a signal/channel (e.g., RSRP) transmitted from the network. The power level may be a received power of a carrier-wave (signal) transmitted from the network. For example, if the power level is lower, the UE may select a radio resource pool in a later time occasion. If the power level is higher, the UE may select a radio resource pool in an earlier time occasion. For example, if the power level is lower, the UE may select a radio resource pool, wherein (logical) time occasions or TTIs of the radio resource pool are separated with a longer time gap in time domain. If the power level is higher, the UE may select a radio resource pool, wherein (logical) time occasions or TTIs of the radio resource pool are separated with a shorter time gap in time domain.

The power level may be a (downlink) pathloss derived/determined based on at least the received power of the signal/channel transmitted from the network. The power level may be a (downlink) pathloss derived/determined based on at least the received power of the carrier-wave (signal) transmitted from the network. For example, if the power level is higher, the UE may select a radio resource pool in a later time occasion. If the power level is lower, the UE may select a radio resource pool in an earlier time occasion. For example, if the power level is higher, the UE may select a radio resource pool, wherein (logical) time occasions or TTIs of the radio resource pool are separated with a longer time gap in time domain. If the power level is lower, the UE may select a radio resource pool, wherein (logical) time occasions or TTIs of the radio resource pool are separated with a shorter time gap in time domain.

The power level may be an expected/derived/determined UE transmit power for backscattering transmission.

The power level may be an expected/derived/determined UE transmit power for UL transmission generated internally by the UE.

The power level may be a maximum UE transmit power.

The power level may be the amount of the UE's battery power/stored power/available power. The UE may estimate/determine/derive how much of the battery power/stored power/available power is utilizable/available for performing a (corresponding) UL transmission.

The power level may be a power difference between the battery power/stored power/available power and the expected/derived/determined/maximum UE transmit power. The expected/derived/determined UE transmit power may be for backscattering transmission or for UL transmission generated internally by the UE. The UE may estimate/determine/derive how much of the battery power/stored power/available power is utilizable for performing (corresponding) UL transmission.

### Type of Data/Signaling (to be Transmitted or Received)

The types may be differentiated by at least use case, traffic scenario, service type, Quality of Service (QoS), logical channel (group), and/or topology. The type may be indicated by the network, determined by the UE, or indicated by a higher layer of the UE. The UE may initiate or trigger the UL transmission for transmitting the UL data.

### Size of UL Grant

The size of a required UL grant may be calculated/derived/determined by the UE. The size may be corresponding to the UL data type. The size of the required UL grant may be calculated/derived/determined based on data available for transmission in the UE. The size may be (potential) a Transport Block Size (TBS) of a UL data. The UE may initiate or trigger the UL transmission for transmitting the UL data.

After the size of the required UL grant is calculated/derived/determined by the UE, the UE may select a radio resource (pool) accordingly. For example, the UE may select a resource pool associated with a size of the UL grant larger than or equal to the size of the required UL grant. For example, the UE may select a resource pool, wherein a scheduling/transmission frequency unit in the resource pool is larger than or equal to a threshold associated with the size of the required UL grant. For example, the UE may select a radio resource larger than or equal to the size of the required UL grant.

After the size of the required UL grant is calculated/derived/determined by the UE, the UE may select a time domain allocation, frequency domain allocation, and/or BWP for radio resource, accordingly. For example, the UE may select a time domain allocation associated with a size of the UL grant larger than or equal to the size of the required UL grant. For example, the UE may select a frequency domain allocation larger than or equal to the size of the required UL grant.

### UE ID

A UE may be assigned a UE ID. The UE may be predefined or (pre-) configured (e.g., by the UE) the UE ID. The UE may be configured or indicated (e.g., by the NW) the UE ID. The UE may calculate, select, derive, or determine the UE ID by itself. The UE ID may be a temporary ID. The UE ID may be a random number, e.g., generated by the UE.

The UE may select a radio resource (pool) based on a modulo calculation and (complete or part of) the UE ID. For example, the UE may select a radio resource (pool) based on (complete or part of) the UE ID mod (the number of radio resource (pool)).

The UE may select a time domain allocation based on a modulo calculation and (complete or part of) the UE ID. For example, the UE may select a time domain allocation based on (complete or part of) the UE ID mod (the number of time domain allocations).

The UE may select a frequency domain allocation based on a modulo calculation and (complete or part of) the UE ID. For example, the UE may select a frequency domain allocation based on (complete or part of) the UE ID mod (the number of frequency domain allocations).

The UE may determine/derive a radio resource pool based on a received DL signaling (e.g., DCI, PRDCH, PDCCH, FL/DL command, paging message, query), wherein the DL signaling may comprise an association between the radio resource pool and (complete or part of) the UE ID.

The UE may determine/derive (time domain allocation and/or frequency domain allocation of) a radio resource based on a received DL signaling (e.g., DCI, PRDCH, PDCCH, FL/DL command, paging message, query), wherein the DL signaling may comprise an association between (time domain allocation and/or frequency domain allocation of) the radio resource and (complete or part of) the UE ID.

The UE may select a BWP based on a modulo calculation and (complete or part of) the UE ID. For example, the UE may select a BWP based on (complete or part of) the UE ID mod (the number of BWPs).

### UE Group

There may be multiple UE groups. A UE may be assigned or associated with a UE group. The UE may be predefined or (pre-) configured (e.g., by the UE) with the UE group. The UE may be configured or indicated (e.g., by the NW) with the UE group. The UE may receive a group ID and/or a value to derive/determine the group ID via query, paging, SIB, PRDCH, and/or PDCCH. The UE may receive a group ID and/or a value to derive/determine the group ID during registration or authentication.

The multiple UEs may be assigned to different UE groups based on the UE types. The UEs with the same UE type may be in a same UE group. The UEs with the same UE type may be in different UE groups. A UE group may comprise UEs with the same or different UE type.

The multiple UEs may be assigned to or associated with different UE groups based on the UE ID. For example, a UE may be assigned to or associated with a UE group, wherein the UE group ID of the UE group may be decided/derived/determined based on at least the UE ID of the UE and a value. Preferably in certain embodiments, the UE group ID of the UE may be decided/derived/determined by the UE ID mod the value. The value may be the number of UE groups. The value may be provided by the NW or be pre-defined or be (pre-) configured. The UE group ID of the UE may be decided by a formula using the UE ID.

The UE may select a radio resource (pool) based on a modulo calculation and (complete or part of) the UE group ID. For example, the UE may select a radio resource (pool) based on (complete or part of) the UE group ID mod (the number of radio resource (pool)).

The UE may select a time domain allocation based on a modulo calculation and (complete or part of) the UE group ID. For example, the UE may select a time domain allocation based on (complete or part of) the UE group ID mod (the number of time domain allocations).

The UE may select a frequency domain allocation based on a modulo calculation and (complete or part of) the UE group ID. For example, the UE may select a frequency domain allocation based on (complete or part of) the UE group ID mod (the number of frequency domain allocations).

The UE may determine/derive a radio resource pool based on a received DL signaling (e.g., DCI, PRDCH, PDCCH, FL/DL command, paging message, query), wherein the DL signaling may comprise association between the radio resource pool and (complete or part of) the UE group ID.

The UE may determine/derive (time domain allocation and/or frequency domain allocation of) a radio resource based on a received DL signaling (e.g., DCI, PRDCH, PDCCH, FL/DL command, paging message, query), wherein the DL signaling may comprise association between (time domain allocation and/or frequency domain allocation of) the radio resource and (complete or part of) the UE group ID.

The UE may select a BWP based on a modulo calculation and (complete or part of) the UE group ID. For example, the UE may select a BWP based on (complete or part of) the UE group ID mod (the number of BWPs).

### Sensing

The UE may determine the occupancy of a radio resource (pool) by performing sensing. The UE may determine whether the radio resource (pool) is occupied based on a threshold for signaling power. The UE may perform sensing with a periodicity.

The UE may select the radio resource (pool) if (at least) the radio resource (pool) is not occupied by other UEs (in the corresponding time). The UE may not select the radio resource (pool) if (at least) the resource pool is occupied by other UEs (in the corresponding time).

The UE may select a radio resource (pool) if (at least) the signaling power of the radio resource (pool) is lower than or equal to a threshold (in the corresponding time). The UE may not select the radio resource (pool) if (at least) the signaling power of the radio resource (pool) is larger than or equal to the threshold (in the corresponding time).

The UE may select a time domain allocation if (at least) the signaling power of the radio resource with the time domain allocation is lower than or equal to a threshold (in the corresponding time). The UE may not select the time domain allocation if (at least) the signaling power of the radio resource with the time domain allocation is larger than or equal to the threshold (in the corresponding time).

The UE may select a frequency domain allocation if (at least) the signaling power of the radio resource with the frequency domain allocation is lower than or equal to a threshold (in the corresponding time). The UE may not select the frequency domain allocation if (at least) the signaling power of the radio resource with the frequency domain allocation is larger than or equal to the threshold (in the corresponding time).

### Repetition Number

A UE may transmit the same TB repeatedly on the selected/determined radio resource. The repetition number may correspond to the number of transmission(s) (e.g., N) of the TB for UL transmission. The UE may perform a new transmission of the TB on the selected/determined radio resource before performing the rest of the retransmission(s) (e.g., for N-1 times) on the selected/determined radio resource.

The UE may select a radio resource (pool) associated with a first repetition number larger than or equal to a second repetition number required/determined/estimated by the UE.

The UE may select a time domain allocation associated with a first repetition number larger than or equal to a second repetition number required/determined/estimated by the UE.

The UE may select a frequency domain allocation associated with a first repetition number larger than or equal to a second repetition number required/determined/estimated by the UE.

The UE may select a BWP associated with a first repetition number larger than or equal to a second repetition number required/determined/estimated by the UE.

### Random Selection

The UE may select a radio resource (pool) randomly.

The UE may select a time domain allocation randomly.

The UE may select a frequency domain allocation randomly.

The UE may select a BWP randomly.

### Order of UE Indicated in a Paging Message

For example, when the UE's ID or group ID is the first one indicated in a list (of multiple UE IDs and/or multiple group IDs) of the paging message, the UE may select the first radio resource (pool). When the UE's ID or group ID is the second one indicated in a list (of multiple UE IDs and/or multiple group IDs) of the paging message, the UE may select the second radio resource (pool).

The UE may select a radio resource (pool) based on a modulo calculation and the (ascending or descending) order (of the UE's ID or UE group ID indicated in the paging message). For example, the UE may select a radio resource (pool) based on the (ascending or descending) order mod (the number of radio resource (pool)).

For example, when the UE's ID or group ID is the first one indicated in a list of the paging message, the UE may select the first time domain allocation. When the UE's ID or group ID is the second one indicated in a list of the paging message, the UE may select the second time domain allocation.

The UE may select a time domain allocation based on a modulo calculation and the (ascending or descending) order (of the UE's ID or UE group ID indicated in the paging message). For example, the UE may select a time domain allocation based on the (ascending or descending) order mod (the number of time domain allocations).

For example, when the UE's ID or group ID is the first one indicated in a list of the paging message, the UE may select the first frequency domain allocation. When the UE's ID or group ID is the second one indicated in a list of the paging message, the UE may select the second frequency domain allocation.

The UE may select a frequency domain allocation based on a modulo calculation and the (ascending or descending) order (of the UE's ID or UE group ID indicated in the paging message). For example, the UE may select a frequency domain allocation based on the (ascending or descending) order mod (the number of frequency domain allocations).

For example, when the UE's ID or group ID is the first one indicated in a list of the paging message, the UE may select the first BWP. When the UE's ID or group ID is the second one indicated in a list of the paging message, the UE may select the second BWP.

The UE may select a BWP based on a modulo calculation and the (ascending or descending) order (of the UE's ID or UE group ID indicated in the paging message). For example, the UE may select a BWP based on the (ascending or descending) order mod (the number of BWPs).

Indication from Network

The network may determine which radio resource pool and/or radio resource to be used by the UE. The UE may receive an indication of which radio resource pool and/or radio resource to be used by the UE from the network. The network may transmit one or multiple DL signalings or DL commands for indicating the same indication.

The UE may not need to perform selection of the radio resource pool. Alternatively in certain embodiments, the UE may need to perform selection of the radio resource pool.

The UE may not need to perform selection of the radio resource from a radio resource pool. Alternatively in certain embodiments, the UE may need to perform selection of the radio resource from a radio resource pool.

The network may determine which time domain allocation, frequency domain allocation, and/or BWP to be used by the UE. The UE may receive an indication of which time domain allocation, frequency domain allocation, and/or BWP to be used by the UE from the network.

The UE may not need to perform selection of time domain allocation. Alternatively in certain embodiments, the UE may need to perform selection of time domain allocation.

The UE may not need to perform selection of frequency domain allocation. Alternatively in certain embodiments, the UE may need to perform selection of frequency domain allocation.

The UE may not need to perform selection of BWP. Alternatively in certain embodiments, the UE may need to perform selection of BWP.

### Closest or Nearest Radio Resource

The UE may select the closest or nearest radio resource (able and/or feasible for the UE to use) in a (determined) radio resource pool. The UE may select the closest or nearest radio resource (able and/or feasible for the UE to use) among radio resource pools.

The UE may select the closest or nearest radio resource (able and/or feasible for the UE to use) among multiple time domain allocations.

Association(s) between the first factor and radio resource pool(s) may be indicated or configured in a configuration by the NW. Preferably in certain embodiments, the association(s) may be acquired via PRDCH. Preferably in certain embodiments, the association(s) may be acquired via query. Preferably in certain embodiments, the association(s) may be acquired via system information. Preferably in certain embodiments, the association(s) may be acquired via paging. Preferably in certain embodiments, the association(s) may be acquired via PDCCH. Alternatively in certain embodiments, the association(s) may be determined by the UE. Alternatively in certain embodiments, the association(s) may be fixed.

Threshold(s) for the first factor may be indicated or configured by the NW. Alternatively in certain embodiments, the threshold(s) may be determined by the UE. Alternatively in certain embodiments, the threshold(s) may be fixed.

Association(s) between the second factor and radio resource(s) may be indicated or configured in a configuration by the NW. Preferably in certain embodiments, the association(s) may be acquired via PRDCH. Preferably in certain embodiments, the association(s) may be acquired via query. Preferably in certain embodiments, the association(s) may be acquired via system information. Preferably in certain embodiments, the association(s) may be acquired via paging. Preferably in certain embodiments, the association(s) may be acquired via PDCCH. Alternatively in certain embodiments, the association(s) may be determined by the UE. Alternatively in certain embodiments, the association(s) may be fixed.

Threshold(s) for the second factor may be indicated or configured by the NW. Alternatively in certain embodiments, the threshold(s) may be determined by the UE. Alternatively in certain embodiments, the threshold(s) may be fixed.

Association(s) between the third factor and time domain allocation and/or frequency domain allocation of radio resource(s) may be indicated or configured in a configuration by the NW. Preferably in certain embodiments, the association(s) may be acquired via PRDCH. Preferably in certain embodiments, the association(s) may be acquired via query. Preferably in certain embodiments, the association(s) may be acquired via system information. Preferably in certain embodiments, the association(s) may be acquired via paging. Preferably in certain embodiments, the association(s) may be acquired via PDCCH. Alternatively in certain embodiments, the association(s) may be determined by the UE. Alternatively in certain embodiments, the association(s) may be fixed.

Threshold(s) for the third factor may be indicated or configured by the NW. Alternatively in certain embodiments, the threshold(s) may be determined by the UE. Alternatively in certain embodiments, the threshold(s) may be fixed.

A UE may transmit the same TB repeatedly on the selected/determined radio resource. The repetition number may correspond to the number of transmission(s) (e.g., N) of the TB for UL transmission. The UE may perform a new transmission of the TB on the selected/determined radio resource before performing the rest of the retransmission(s) (e.g., for N-1 times) on the selected/determined radio resource.

The repetition number (to be used by the UE) may be selected/determined by the UE from (possible) configured/predefined repetition numbers. Alternatively in certain embodiments, the repetition number (to be used by the UE) may be assigned by the network.

The repetition number may be selected/determined based on signal power strength (e.g., RSRP). For example, the UE may select a repetition number if at least a threshold (e.g., for RSRP) is fulfilled. The UE may not select a repetition number if at least the threshold is not fulfilled. The UE may select a repetition number once the threshold is fulfilled. The UE may not select a repetition number until the threshold is fulfilled.

For example, the UE may select a repetition number if at least the power measurement (e.g., RSRP) is larger than or equal to a threshold (e.g., for RSRP). The UE may not select the repetition number if at least the power measurement is smaller than or equal to the threshold. The UE may select the repetition number once the power measurement is larger than or equal to the threshold. The UE may select a first repetition number if at least the power measurement is larger than or equal to a first threshold (e.g., for RSRP) and is smaller than a second threshold (e.g., for RSRP). The UE may select a second repetition number if at least the power measurement is smaller than the first threshold (e.g., for RSRP). The UE may select a third repetition number if at least the power measurement is larger than the second threshold (e.g., for RSRP).

For example, the UE may select a repetition number if at least the power measurement (e.g., RSRP) is smaller than or equal to a threshold (e.g., for RSRP). The UE may not select the repetition number if at least the power measurement is higher than or equal to the threshold. The UE may select the repetition number once the power measurement is smaller than or equal to the threshold. The UE may select a first repetition number if at least the power measurement is smaller than or equal to a first threshold (e.g., for RSRP) and is larger than a second threshold (e.g., for RSRP). The UE may select a second repetition number if at least the power measurement is larger than the first threshold (e.g., for RSRP). The UE may select a third repetition number if at least the power measurement is smaller than the second threshold (e.g., for RSRP).

For example, the repetition number may be selected/determined based on the peak transmission power. The UE may select a repetition number if at least a threshold (for peak transmission power) is fulfilled. The UE may not select a repetition number if at least the threshold is not fulfilled. The UE may select a repetition number once the threshold is fulfilled. The UE may not select a repetition number until the threshold is fulfilled.

For example, the UE may select a first repetition number if at least the peak transmission power of the UE is a first value. The UE may select a second repetition number if at least the peak transmission power of the UE is a second value.

The repetition number may be selected/determined based on the UE's battery power/stored power/available power/power level. For example, the UE may select a repetition number if at least a threshold (for the amount of the UE's battery power/stored power/available power) is fulfilled. The UE may not select a repetition number if at least the threshold is not fulfilled. The UE may select a repetition number once the threshold is fulfilled. The UE may not select a repetition number until the threshold is fulfilled.

For example, the UE may select a repetition number if at least the UE's battery power/stored power/available power/power level is larger than or equal to a threshold. The UE may not select the repetition number if at least the UE's battery power/stored power/available power/power level is smaller than or equal to the threshold. The UE may select the repetition number once the UE's battery power/stored power/available power/power level is larger than or equal to the threshold. The UE may select a first repetition number if at least the UE's battery power/stored power/available power/power level is larger than or equal to a first threshold and is smaller than a second threshold. The UE may select a second repetition number if at least the UE's battery power/stored power/available power/power level is smaller than the first threshold. The UE may select a third repetition number if at least the UE's battery power/stored power/available power/power level is larger than the second threshold.

The repetition number may be selected/determined based on the UE type. For example, the first UE may select a repetition number (e.g., if (at least) the first UE is a device A in [2] 3GPP TR 38.848 V18.0.0 (2023-09)). The first UE may select multiple repetition numbers (e.g., if (at least) the first UE is a device A in [2] 3GPP TR 38.848 V18.0.0 (2023-09)). A second UE may not be the same type as the first UE (e.g., the second UE is a device C in [2] 3GPP TR 38.848 V18.0.0 (2023-09)). The second UE may select the same repetition number(s) as the first UE selects. The second UE may not select the same repetition number(s) as the first UE selects. The second UE may select different repetition number(s) as the first UE selects.

In addition, the UL transmission of each repetition may take place in different patterns of time occasions. The retransmission(s) may take place in consecutive time occasion(s). The retransmission(s) may take place in every fixed time occasion(s). The time occasion(s) between two retransmissions may be different.

The pattern of repetitions may be pre-defined or be (pre-) configured. A UE may be pre-defined/(pre-) configured with multiple patterns of repetition. The UE may decide a pattern of repetition among the pre-defined/(pre-) configured patterns.

The pattern (to be used by the UE) may be selected/determined by the UE from (possible) configured/predefined patterns. Alternatively in certain embodiments, the pattern (to be used by the UE) may be assigned by the network.

The pattern of repetition may be associated with a radio resource pool. For example, the UE may select the pattern of repetition if (at least) the selected/determined resource pool is associated with the pattern. The UE may not select the pattern of repetition if (at least) the selected/determined resource pool is not associated with the pattern.

The pattern of repetition may be selected based on signal power strength (e.g., RSRP). For example, the UE may select a repetition pattern if at least a threshold (e.g., for RSRP) is fulfilled. The UE may not select a repetition pattern if at least the threshold is not fulfilled. The UE may select a repetition pattern once the threshold is fulfilled. The UE may not select a repetition pattern until the threshold is fulfilled.

For example, the UE may select a pattern if at least the power measurement (e.g., RSRP) is larger than or equal to a threshold (e.g., for RSRP). The UE may not select the pattern if at least the power measurement is smaller than or equal to the threshold. The UE may select the pattern once the power measurement is larger than or equal to the threshold. The UE may select a first pattern if at least the power measurement is larger than or equal to a first threshold (e.g., for RSRP) and is smaller than a second threshold (e.g., for RSRP). The UE may select a second pattern if at least the power measurement is smaller than the first threshold (e.g., for RSRP). The UE may select a third pattern if at least the power measurement is larger than the second threshold (e.g., for RSRP).

For example, the UE may select a pattern if at least the power level of the UE is larger than or equal to a threshold. The UE may select the pattern if at least the power level of the UE is a specific value. The UE may not select the pattern if at least the power level of the UE is smaller than or equal to the threshold. The UE may not select the pattern if at least the power level of the UE is not the specific value. The UE may select the pattern once the power level of the UE is larger than or equal to the threshold. The UE may select a first pattern if at least the power level of the UE is larger than or equal to a first threshold and is smaller than a second threshold. The UE may select a second pattern if at least the power level of the UE is smaller than the first threshold. The UE may select a third pattern if at least the power level of the UE is larger than the second threshold.

Preferably in certain embodiments, a time gap between resources of one pattern may be different or the same for different patterns. The time gap of the second pattern may be longer than or equal to the time gap of the first pattern, and/or the time gap of the first pattern may be longer than or equal to the time gap of the third pattern. Preferably in certain embodiments, different patterns may be applied in different timings (e.g., during carrier wave duration). The third pattern may be applied/utilized earlier than the first pattern, and/or the first pattern may be applied/utilized earlier than the second pattern.

The pattern of repetitions may be determined based on the UE type. The first UE may be pre-defined/(pre-) configured with a repetition pattern (e.g., if (at least) the first UE is a device A in [2] 3GPP TR 38.848 V18.0.0 (2023-09)). The first UE may be pre-defined/(pre-) configured with multiple repetition patterns. The second UE may not be the same type as the first UE (e.g., the second UE is a device C in [2] 3GPP TR 38.848 V18.0.0 (2023-09)). The second UE may be pre-defined/(pre-) configured with the same repetition pattern(s) as the first UE is pre-defined/(pre-) configured. The second UE may not be pre-defined/(pre-) configured with the same repetition pattern(s) as the first UE is pre-defined/(pre-) configured. The second UE may be pre-defined/(pre-) configured with different repetition number(s) as the first UE is pre-defined/(pre-) configured. The second UE may use a repetition pattern different from that used by the first UE.

Note that any of the above and herein methods, alternatives, concepts, examples, and embodiments may be combined, in whole or in part, or applied simultaneously or separately.

The UE may receive a configuration(s) related to ambient IoT. The UE may receive a configuration(s) and/or radio resource(s) for UL transmission. Throughout the present disclosure, the following may be interchangeable: configuration, proper configuration, first configuration.

The power level may be (represented) a power status of the UE.

Throughout the present disclosure, the UL may be replaced by D2R or “device to reader”. The UL transmission may be a transmission from an ambient IoT device (or ambient IoT UE) to a reader (or base station, network node, intermediate node, intermediate UE).

Throughout the present disclosure, the DL may be replaced by R2D or “reader to device”. The DL transmission may be a transmission from a reader (or base station, network node, intermediate node, intermediate UE) to an ambient IoT device (or ambient IoT UE).

Throughout the present disclosure, the reader may be and/or be replaced by NW, UE, and/or intermediate node. Throughout the present disclosure, the device may be and/or be replaced by UE and/or intermediate node. The device may be referred to as an ambient IoT device. The “UE” may comprise a reader and/or device. The “NW/intermediate node” may comprise a reader. The UE/device may receive carrier wave(s) from a reader. The UE/device may receive carrier wave(s) from a node other than the reader.

Throughout the present disclosure, the “PDRCH” may be replaced by “physical channel for D2R (data/control) transmission”, “physical device to reader channel”, and/or “a channel for transmission from device to reader”.

Throughout the present disclosure, the “PRDCH” may be replaced by “physical channel for R2D (data/control) transmission”, “physical reader to device channel”, and/or “a channel for transmission from reader to device”.

Throughout the present disclosure, the “Physical Uplink Shared Channel (PUSCH)” may be replaced by “uplink shared channel”, “PUSCH for ambient IoT”, “PDRCH”, or “physical channel for D2R (data/control) transmission”.

Throughout the present disclosure, the “PDCCH” may be replaced by “downlink control channel”, “downlink control information”, “PDCCH for ambient IoT”, “PRDCH”, or “physical channel for R2D (data/control) transmission”.

Throughout the present disclosure, the “DCI” may be replaced by R2D control information.

Throughout the present disclosure, the “UCI” may be replaced by D2R control information.

Throughout the present disclosure, the DCI may be transmitted via PRDCH.

Throughout the present disclosure, the DCI may be transmitted via PDCCH.

Throughout the present disclosure, the DCI may be transmitted via FL/DL/R2D command.

Throughout the present disclosure, the “Physical Downlink Shared Channel (PDSCH)” may be replaced by “downlink shared channel”, “PDSCH for ambient IoT”, “PRDCH”, or “physical channel for R2D (data) transmission”.

Throughout the present disclosure, the “BWP” may be replaced by “system bandwidth”, “channel bandwidth”, “transmission bandwidth”, “occupied bandwidth”, “sub-band of/in a cell”, or “subset of the total cell bandwidth of a cell”.

Throughout the present disclosure, the “cell” may be replaced by “intermediate node”.

Throughout the present disclosure, the radio resource (pool) may only be used by Ambient IoT UE(s). The radio resource (pool) may not be allowed to be used by non-Ambient IoT UE(s). Throughout the present disclosure, the radio resource pool may not be a sidelink resource pool for Physical Sidelink Shared Channel (PSSCH) and/or Sidelink Positioning Reference Signal (SL PRS).

Throughout the present disclosure, the radio resource (pool) may be used for a link (e.g., Uu link, R2D, D2R, UL, DL, or SL) between the UE and the network.

Throughout the present disclosure, the “UL resource (pool)” may be replaced by “radio resource (pool) for D2R transmission” or “radio resource (pool) for UL transmission”.

Throughout the present disclosure, the “retransmission” may be replaced by “repetition for D2R transmission” or “repetition for UL transmission”.

Throughout the present disclosure, the network (node) may be changed/represented/replaced as intermediate node or reader.

Throughout the present disclosure, the query may be changed/represented/replaced as a query message.

Throughout the present disclosure, the query may be changed/represented/replaced as DCI/PRDCH/PDCCH scheduling/including a query message.

Throughout the present disclosure, the query may be changed/represented/replaced as FL/DL/R2D command scheduling/including a query message.

Throughout the present disclosure, the paging may be changed/represented/replaced as a paging message or query (message).

Throughout the present disclosure, the paging may be changed/represented/replaced as DCI/PDCCH scheduling/including a paging message.

Throughout the present disclosure, the paging may be changed/represented/replaced as FL/DL/R2D command scheduling/including a paging message.

Throughout the present disclosure, the (data and/or signaling) transmission or reception may be via R2D.

Throughout the present disclosure, the (data and/or signaling) transmission or reception may be via D2R.

Throughout the present disclosure, the (data and/or signaling) transmission or reception may be via UL.

Throughout the present disclosure, the (data and/or signaling) transmission or reception may be via DL.

Throughout the present disclosure, the (data and/or signaling) transmission or reception may be via SL.

Throughout the present disclosure, the (data and/or signaling) transmission or reception may be via PRDCH. Throughout the present disclosure, the (data and/or signaling) transmission or reception may be via PDRCH.

Throughout the present disclosure, the (data and/or signaling) transmission or reception may be via PUSCH.

Throughout the present disclosure, the (data and/or signaling) transmission or reception may be via PDSCH.

Throughout the present disclosure, the (data and/or signaling) transmission or reception may be a Message A (MsgA) transmission.

Throughout the present disclosure, the (data and/or signaling) transmission or reception may be a Message 3 (Msg3) transmission.

Throughout the present disclosure, the (data and/or signaling) transmission may be replaced by a D2R transmission (from device to reader).

Throughout the present disclosure, the (data and/or signaling) reception may be replaced by an R2D reception (from reader to device).

Throughout the present disclosure, the DL may be replaced by FL or R2D.

Throughout the present disclosure, the UL may be replaced by Backward Link (BL) or D2R.

Throughout the present disclosure, the “RA (random access)” may be, be replaced by, and/or be referred to as an access procedure performed by the (ambient IoT) UE/device. The resource(s) and/or configuration(s) for the access procedure may comprise PDRCH resource(s), occasion(s), frequency, and/or band, e.g., for D2R transmission. The resource(s) and/or configuration(s) for the access procedure may comprise a parameter, random number, group number, and/or assistance information, e.g., for D2R transmission.

Throughout the present disclosure, the “2-step RA” may be, be replaced by, and/or be referred to as a 2-step access procedure performed by the (ambient IoT) UE/device.

Throughout the present disclosure, the “4-step RA” may be, be replaced by, and/or be referred to as a 4-step access procedure performed by the (ambient IoT) UE/device.

The UE may perform a procedure of RA, (initial) access, (ambient IoT) response/report, and/or (R2D/D2R) transmission. The procedure may be a procedure described above (throughout the present disclosure). The UE may access the NW/intermediate node, receive signaling/message/configuration, and/or transmit (D2R) data via the procedure. The UE may receive a signaling from the NW/intermediate node (e.g., from a reader). The signaling may be a signaling described above. The signaling may be a query, paging, indication, and/or a R2D message. The RA may be Contention-Based Random Access (CBRA) or Contention-Free Random Access (CFRA).

In response to receiving the signaling, the UE may trigger/perform the procedure and/or the following transmission. In the procedure, the UE may transmit a first transmission to the NW/intermediate node. The NW/intermediate node may transmit a second transmission to the UE in response to reception/detection of the first transmission. In response to or after transmitting the first transmission, the UE may receive a second transmission from the NW/intermediate node. In response to receiving the second transmission, the UE may transmit a third transmission to the NW/intermediate node. The NW/intermediate node may transmit a fourth transmission to the UE in response to reception of the third transmission. The NW/intermediate node may not transmit the fourth transmission to the UE in response to reception of the third transmission. In response to or after transmitting the third transmission, the UE may or may not receive a fourth transmission from the NW/intermediate node. In response to receiving the fourth transmission, the UE may transmit a fifth transmission to the NW/intermediate node.

The signaling may include/indicate (at least one) (e.g., dedicated/contention-free) (radio) resource for the first transmission. In response to receiving the signaling, the UE may determine/derive/select a resource (from the resource included/indicated in the signaling) to perform the first transmission in the procedure. The (radio) resource included/indicated in the first signaling may comprise at least time domain radio resources and/or frequency domain radio resources. Alternatively and/or additionally in certain embodiments, the signaling may include a configuration related to (radio) resources. The configuration included/indicated in the signaling may include/indicate time domain allocations and/or frequency domain allocations of the (radio) resources. The configuration included/indicated in the signaling may include/indicate an association between the (radio) resource and the UE(s) (and/or UE group(s)). The first transmission in the procedure may be/comprise information of a random number (e.g., in the case of CBRA and/or CFRA). The first transmission in the procedure may be/comprise information of a preamble number and/or information of an (access) ID selected/generated/determined by the UE.

The second transmission in the procedure may be a response to the first transmission and/or an acknowledgement. The second transmission may indicate, identify, and/or correspond to the first transmission. The second transmission may provide resource(s) for the following D2R transmissions, e.g., the third transmission.

The third transmission in the procedure may be/comprise information of a UE/device ID, report, assistance information, D2R data, and/or information from the UE.

The fourth transmission in the procedure may be a response to the third transmission, an acknowledgement, a DL/R2D command, a R2D data, and/or a scheduling. The fourth transmission may indicate, identify, and/or correspond to the third transmission. The fourth transmission may provide resource(s) for the following D2R transmissions. The fourth transmission may indicate, notify, and/or allow the fifth transmission.

The fifth transmission in the procedure may be/comprise a feedback (of the fourth transmission), report, assistance information, D2R data, and/or information from the UE.

The first transmission, third transmission, and fifth transmission may be D2R transmissions and/or PDRCH transmissions. The signaling, second transmission, and fourth transmission may be R2D transmissions and/or PRDCH transmissions. The signaling and second transmission may be broadcast, provided and/or transmitted to one or multiple UEs. The second transmission and fourth transmission may be provided and/or transmitted to a dedicated UE. The fourth transmission and/or the fifth transmission may be a subsequent transmission during or after the procedure.

Throughout the present disclosure, a Message 1 (Msg1) and/or MSGA may be replaced by a first transmission. Throughout the present disclosure, a Message 2 (Msg2), Random Access Response (RAR) and/or Message B (MSGB) may be replaced by a second transmission. Throughout the present disclosure, a MSGA and/or Msg3 may be replaced by a third transmission. Throughout the present disclosure, a MSGB and/or Message 4 (Msg4) may be replaced by a fourth transmission. Throughout the present disclosure, a Message 5 (Msg5) may be replaced by a fifth transmission.

An identity of the UE and/or a UE ID may be or comprise a random number, temporary number, preamble number (e.g., RAPID), a temporary number, and/or an ID selected/generated/determined by the UE. An identity of the UE and/or a UE ID may be or comprise a device ID, UE ID, group ID, Contention Resolution Identity, and/or RNTI of the UE. The (access) ID comprised in the first transmission may be different from the device/UE ID comprised in the third transmission.

Throughout the present disclosure, the following may be interchangeable: “initiate a procedure”, “perform a procedure”, “trigger a procedure”, and/or “execute a procedure”.

The UE may be referred to as the UE, an RRC layer of the UE, a MAC entity of the UE, or a physical layer of the UE.

Throughout the present disclosure, the UE may be an ambient IoT device/UE. The UE may be a device used for ambient IoT. The UE may be a device capable of ambient IoT. The UE may be an NR device. The UE may be a Long Term Evolution (LTE) device. The UE may be an IoT device. The UE may be a wearable device. The UE may be a sensor. The UE may be a stationary device. The UE may be a tag. Throughout the present disclosure, the following may be interchangeable: (ambient IoT) UE, (ambient IoT) device.

The UE may not be a legacy UE. The legacy UE may be a non-ambient IoT device. The legacy UE may perform different procedures from the ambient IoT UE. The UE may be a legacy UE with capability to perform ambient IoT procedures. Throughout the present disclosure, the following may be interchangeable: normal UE, legacy UE. The ambient IoT UE may have capability of an ambient IoT. The legacy UE may or may not have capability of an ambient IoT procedure.

The network may be a network node. The network (node) may be a base station. The network (node) may be an access point. The network (node) may be an Evolved Node B (eNB). The network (node) may be a Next Generation Node B (gNB). The network (node) may be a gateway. The network (node) may be a reader.

Various examples and embodiments of the present invention are described below. For the methods, alternatives, concepts, examples, and embodiments detailed above and herein, the following aspects and embodiments are possible.

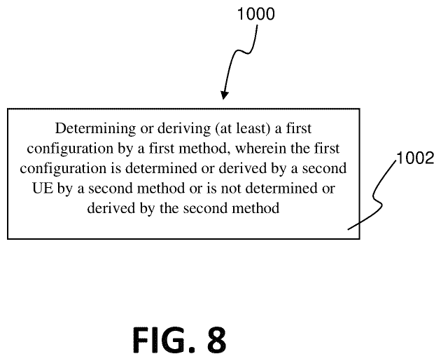

Referring to FIG. 8, with this and other concepts, systems, and methods of the present invention, a method 1000 for a first UE in a wireless communication system comprises determining or deriving (at least) a first configuration by a first method, wherein the first configuration is determined or derived by a second UE by a second method or is not determined or derived by the second method (step 1002).

Referring back to FIGS. 3 and 4, in one or more embodiments from the perspective of a first UE in a wireless communication system, the device 300 includes a program code 312 stored in memory 310 of the transmitter. The CPU 308 could execute program code 312 to: (i) determine or derive (at least) a first configuration by a first method, wherein the first configuration is determined or derived by a second UE by a second method or is not determined or derived by the second method. Moreover, the CPU 308 can execute the program code 312 to perform all of the described actions, steps, and methods described above, below, or otherwise herein.

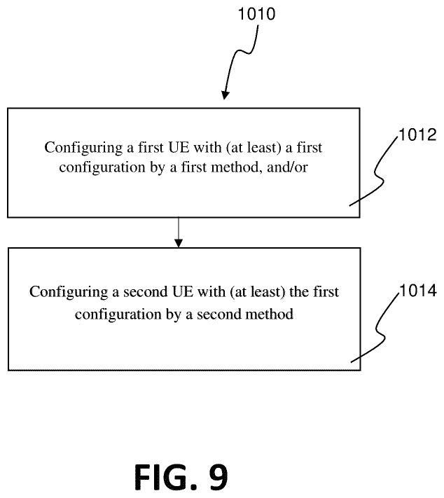

Referring to FIG. 9, with this and other concepts, systems, and methods of the present invention, a method 1010 for a network node in a wireless communication system comprises configuring a first UE with (at least) a first configuration by a first method (step 1012), and/or configuring a second UE with (at least) the first configuration by a second method (step 1014).

Referring back to FIGS. 3 and 4, in one or more embodiments from the perspective of a network node in a wireless communication system, the device 300 includes a program code 312 stored in memory 310 of the transmitter. The CPU 308 could execute program code 312 to: (i) configure a first UE with (at least) a first configuration by a first method; and/or (ii) configure a second UE with (at least) the first configuration by a second method. Moreover, the CPU 308 can execute the program code 312 to perform all of the described actions, steps, and methods described above, below, or otherwise herein.

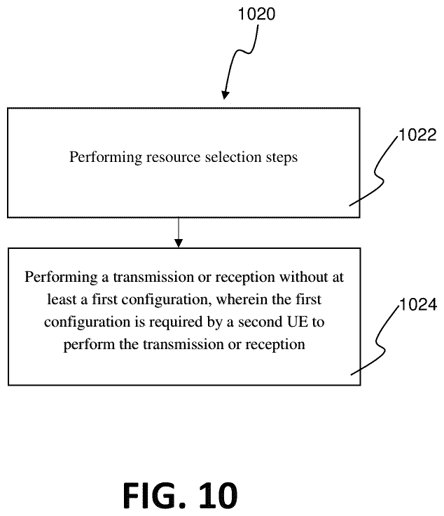

Referring to FIG. 10, with this and other concepts, systems, and methods of the present invention, a method 1020 for a first UE in a wireless communication system comprises performing resource selection steps (step 1022), and performing a transmission or reception without at least a first configuration, wherein the first configuration is required by a second UE to perform the transmission or reception (step 1024).

Referring back to FIGS. 3 and 4, in one or more embodiments from the perspective of a first UE in a wireless communication system, the device 300 includes a program code 312 stored in memory 310 of the transmitter. The CPU 308 could execute program code 312 to: (i) perform resource selection steps; and (ii) perform a transmission or reception without at least a first configuration, wherein the first configuration is required by a second UE to perform the transmission or reception. Moreover, the CPU 308 can execute the program code 312 to perform all of the described actions, steps, and methods described above, below, or otherwise herein.

In various embodiments, the first UE is an ambient IoT UE.

In various embodiments, the second UE is not an ambient IoT UE.

In various embodiments, the first UE determines or derives a first value for the first configuration.

In various embodiments, the second UE determines or derives a second value for the first configuration.

In various embodiments, the first method or the second method is to receive a common signaling from a network node.

In various embodiments, the first method or the second method is to receive a dedicated signaling from a network node.

In various embodiments, the first method or the second method is to pre-configure or pre-define the first configuration.

In various embodiments, the first method and the second method are different.

In various embodiments, the first configuration includes a configuration related to BWP.

In various embodiments, the first configuration includes a configuration related to paging or system information.

In various embodiments, the first configuration includes a configuration related to parameters specific for the first UE.

In various embodiments, the resource selection steps include a radio resource pool selection based on the first configuration.

In various embodiments, the resource selection steps include a radio resource selection among the selected radio resource pool based on the first configuration.

In various embodiments, the resource selection steps include a radio resource allocation selection based on the selected radio resource based on the first configuration.

In various embodiments, the first configuration includes repetition number and patterns of repetition of the UL transmission.

In various embodiments, the first configuration includes a UE type, power level, UL data type, UL data size, UE ID, UE group ID, sensing, and/or repetition number.

In various embodiments, the UL transmission with repetition takes place on the selected radio resource.

An (ambient IoT) UE would initiate a UL procedure (for (data and/or signaling) transmission) or perform (data and/or signaling) transmission when necessary. For example, the (ambient IoT) UE would receive a signaling from the NW. In response to receiving the signaling, the (ambient IoT) UE would initiate the UL procedure or perform the transmission.

The signaling may be used to trigger (or indicate) a UL procedure of the UE. The signaling may be used to trigger (or indicate) a transmission (or reception) of the UE. The transmission from the UE may be (or include) a backscattering transmission (or reception) or may be generated internally by the UE. The signaling may be used to provide a power source and/or energy to the UE. The signaling may be (or include) RRC signaling (e.g., RRC configuration message), MAC signaling (e.g., MAC CE), or PHY signaling (e.g., PDCCH, DCI, FL/DL command). The signaling may be (or include) a carrier wave (signal) and/or interrogation signal.

The signaling may be a common signaling or a dedicated signaling. The common signaling may be (or include) a cell-specific configuration. The common signaling may be (or include) a configuration common for multiple UEs, a group of UEs, and/or a UE group. The common signaling may be (or include) a broadcast signaling, system information, and/or paging message. The dedicated signaling may be (or include) a UE-specific configuration. The dedicated signaling may be (or include) a configuration dedicated for a (single) UE. The dedicated signaling may be (or include) RRC signaling (e.g., RRC configuration message). The dedicated signaling may be (or include) MAC signaling (e.g., MAC CE). The dedicated signaling may be (or include) PHY signaling (e.g., PDCCH, DCI, FL/DL command).

The UE may determine whether or when to initiate (or trigger, perform) a UL procedure or transmission, e.g., in response to or after receiving an NW signaling, UL data/signaling arrival, UL data available for transmission, and/or request from the upper layer (e.g., Non-Access Stratum (NAS)) of the UE. The NW signaling may be a signaling described above. The UE may determine whether or when to initiate (or trigger, perform) a UL procedure based on a first condition(s).

The UE may check the first condition(s), e.g., in response to (or if, when, after) receiving the NW signaling, UL data/signaling arrival, UL data available for transmission, and/or request from the upper layer (e.g., NAS) of the UE. If (at least) (one, some, or all of) the first condition(s) is fulfilled, the UE may initiate, trigger, perform, continue, and/or resume a UL procedure or transmission. If (at least) (one, some, or all of) the first condition(s) is not fulfilled, the UE may not initiate, trigger, and/or continue a UL procedure or transmission. If (at least) (one, some, or all of) the first condition(s) is not fulfilled, the UE may stop, cancel, and/or suspend a UL procedure or transmission.

The UE may initiate, trigger, perform, continue, and/or resume a UL procedure or transmission, if (at least) (one, some, or all of) the first condition(s) is fulfilled, e.g., after or in response to receiving the signaling, UL data/signaling arrival, UL data available for transmission, and/or request from the upper layer (e.g., NAS) of the UE. The UE may not initiate, trigger, and/or continue a UL procedure or transmission, if (at least) (one, some, or all of) the first condition(s) is not fulfilled, e.g., after or in response to receiving the signaling, UL data/signaling arrival, UL data available for transmission, and/or request from the upper layer (e.g., NAS) of the UE. The UE may not initiate, trigger, continue, and/or resume a UL procedure or transmission until (one, some, or all of) the first condition(s) is fulfilled, e.g., after or in response to receiving the signaling, UL data/signaling arrival, UL data available for transmission, and/or request from the upper layer (e.g., NAS) of the UE. The UE may stop, cancel, and/or suspend a UL procedure or transmission, if (at least) (one, some, or all of) the first condition(s) is not fulfilled, e.g., after or in response to receiving the signaling, UL data/signaling arrival, UL data available for transmission, and/or request from the upper layer (e.g., NAS) of the UE. After or when the UE receives the NW signaling, UL data/signaling arrival, UL data available for transmission, and/or request from the upper layer (e.g., NAS) of the UE, the UE may check whether the first condition(s) is fulfilled or not. After or when the UE receives the NW signaling, the UE may check whether the first condition(s) is fulfilled or not in response to UL data/signaling arrival, UL data available for transmission, and/or request from the upper layer (e.g., NAS) of the UE. The UE may initiate a UL procedure or transmission once or after (at least) (one, some, or all of) the first condition(s) is fulfilled. In response to (or if, when, after) receiving the NW signaling, UL data/signaling arrival, UL data available for transmission, and/or request from the upper layer (e.g., NAS) of the UE, the UE may initiate, trigger, continue, and/or resume a UL procedure or transmission once (at least) (one, some, or all of) the first condition(s) is fulfilled. After or when the UE receives the NW signaling, the UE may initiate, trigger, continue, and/or resume a UL procedure or transmission once (at least) (one, some, or all of) the first condition(s) is fulfilled in response to UL data/signaling arrival, UL data available for transmission, and/or request from the upper layer (e.g., NAS) of the UE. After or when the UE receives the NW signaling, if there is no UL data/signaling arrival, UL data available for transmission, and/or request from the upper layer (e.g., NAS) of the UE, the UE may not check whether the first condition(s) is fulfilled or not. After or when the UE receives the NW signaling, if there is no UL data/signaling arrival, UL data available for transmission, and/or request from the upper layer (e.g., NAS) of the UE, the UE may not initiate, trigger, perform, continue, and/or resume a UL procedure or transmission.

Alternatively and/or additionally in certain embodiments, the UE may initiate, trigger, continue, and/or resume a UL procedure or transmission in response to (or if, when, after) receiving the NW signaling, UL data/signaling arrival, UL data available for transmission, and/or request from the upper layer (e.g., NAS) of the UE. The NW signaling may be a signaling described above. The UE may determine whether or when to perform (the very first or first time or first step of) radio resource selection procedure of the UL procedure or transmission based on a first condition(s).

The UE may check the first condition(s) when a UL procedure or transmission is pending. The UL procedure or transmission is pending when, upon, or after the UE receives the NW signaling, UL data/signaling arrival, UL data available for transmission, request from the upper layer (e.g., NAS) of the UE, and/or the UL procedure is triggered (e.g., by the upper layer). The UL procedure or transmission is pending when, upon, or after the UL procedure or transmission is suspended. If (at least) (one, some, or all of) the first condition(s) is fulfilled, the UE may perform (the very first or first time or first step of) a radio resource selection procedure of the UL procedure or transmission. If (at least) (one, some, or all of) the first condition(s) is not fulfilled, the UE may not perform (the very first or first time or first step of) a radio resource selection procedure of the UL procedure or transmission.

The UE may check the first condition(s) in response to initiating, triggering, continuing, and/or resuming the UL procedure or transmission. If (at least) (one, some, or all of) the first condition(s) is fulfilled, the UE may perform (the very first or first time or first step of) a radio resource selection procedure of the UL procedure or transmission. If (at least) (one, some, or all of) the first condition(s) is not fulfilled, the UE may not perform (the very first or first time or first step of) a radio resource selection procedure of the UL procedure or transmission. If (at least) (one, some, or all of) the first condition(s) is not fulfilled, the UE may delay and/or suspend the UL procedure or transmission.

The UE may perform (the very first or first time or first step of) a radio resource selection procedure of the UL procedure or transmission, if (at least) (one, some, or all of) the first condition(s) is fulfilled upon or in response to initiating, triggering, continuing, and/or resuming the UL procedure or transmission. The UE may not perform (the very first or first time or first step of) a radio resource selection procedure of the UL procedure or transmission, if (at least) (one, some, or all of) the first condition(s) is not fulfilled upon or in response to initiating, triggering, continuing, and/or resuming the UL procedure or transmission. The UE may not perform (the very first or first time or first step of) a radio resource selection procedure of the UL procedure or transmission until (one, some, or all of) the first condition(s) is fulfilled, after, or in response to initiating, triggering, continuing, and/or resuming the UL procedure or transmission. The UE may delay and/or suspend the UL procedure or transmission, if (at least) (one, some, or all of) the first condition(s) is not fulfilled upon or in response to initiating, triggering, continuing, and/or resuming the UL procedure or transmission. After or when the UE receives the NW signaling, UL data/signaling arrival, UL data available for transmission, or request from the upper layer (e.g., NAS) of the UE and the UE initiates, triggers, continues, and/or resumes a UL procedure or transmission, (one, some, or all of) the first condition(s) may be fulfilled. The UE may perform (the very first or first time or first step of) a radio resource selection procedure of the UL procedure or transmission once or after (one, some, or all of) the first condition(s) is fulfilled. In response to (or if, when, after) initiating, triggering, continuing, and/or resuming the UL procedure or transmission, the UE may perform (the very first or first time or first step of) a radio resource selection procedure of the UL procedure or transmission once (one, some, or all of) the first condition(s) is fulfilled.

The first condition(s) used to determine whether or when to initiate (or trigger, perform) a UL procedure or transmission and the first condition(s) used to determine whether or when to perform (the very first or first time or first step of) the radio resource selection procedure of the UL procedure or transmission may be the same. Alternatively in certain embodiments, the first condition(s) used to determine whether or when to initiate (or trigger, perform) a UL procedure or transmission and the first condition(s) used to determine whether or when to perform (the very first or first time or first step of) the radio resource selection procedure of the UL procedure or transmission may be (partially or completely) different.

One or more of the first condition(s) may be applied/checked by a first UE and may not be applied/checked by a second UE, e.g., based on a first factor as described below. A first UE and a second UE may have different configurations and/or values for the (one or more of) first condition(s). The first UE and the second UE may be different UEs, e.g., differentiated by the first factor. The first UE and the second UE may be ambient IoT UEs. The UE may determine whether to use the (one or more of) first condition(s) based on the first factor. The UE may determine to use which value of the (one or more of) first condition(s) based on the first factor.

The UL data/signaling may be allowed to be transmitted by the UL procedure or transmission.

The UL procedure may include one or more of the following:
Assignment, from the network, of radio resource for new transmission(s), retransmission(s), and/or repetition(s);
Selection, by the UE, of radio resources for new transmission(s), retransmission(s), and/or repetition(s)
One or more new transmissions in UL;
One or more retransmissions of the new transmission(s);
One or more repetitions of the new transmission(s);
One or more feedback from the network to indicate whether the new transmission(s), the retransmission(s), the repetition(s), or TB(s) from the UE is successfully received by the network;
An indication from the network to stop or complete the UL procedure; and/or
A timer or time duration to control the duration of the UL procedure.

Any of the above and herein methods, alternatives, concepts, examples, and embodiments may be combined, in whole or in part, or applied simultaneously or separately.

The first condition(s) may be (or include) one or more of the following:
Proper configuration.

The first condition(s) may include that the (proper/corresponding) configuration is received, available, determined, derived, and/or valid. For example, this condition may be fulfilled if (at least) the (proper/corresponding) configuration is received, available, determined, derived, and/or valid. This condition may be fulfilled if (at least) a corresponding configuration for a first factor is received, available, determined, derived, and/or valid. This condition may be fulfilled if (at least) the configuration related to the first factor is received, available, determined, derived, and/or valid. This condition may be fulfilled if (at least) the configuration specific to one of the first factor(s) is selected. The configuration may be associated with a first factor. The configuration may be different based on the first factor. The UE may determine whether a configuration is proper based on the first factor. The UE may determine whether a (proper/corresponding) configuration is available and/or valid based on the first factor. This condition may not be fulfilled if (at least) the (proper/corresponding) configuration (related to the first factor) is not received, available, determined, derived, and/or valid.

The (proper) configuration may comprise or indicate one or more of the following:
Configuration related to BWP(s) (of a cell);
Configuration related to paging;
Configuration related to system information;
Configuration related to (data) transmission or reception;
Configuration related to downlink control signaling;
Threshold(s) for power measurement (or signal power strength);
Threshold(s) for power in energy storage;
(Possible) Repetition number(s) (for a (UL) transmission performed by the UE);
(Possible) Repetition pattern(s) (for a (UL) transmission performed by the UE);
Configuration related to a time, time duration, or timer;
Periodicity (ies) of the radio resource;
UE's ID(s);
UE group's ID(s);
time duration(s) for a UE group;
Association between a radio resource (pool) and the UE ID and/or UE group associated with the UE(s);
Association between a radio resource (pool) and order of the UE indicated in a paging message;
configuration for sensing whether a radio resource is used;
Pool(s) of radio resource;
Time domain allocation(s) of the radio resource;
Frequency domain allocation(s) of the radio resource; and/or
BWP(s) associated with the radio resource.

The radio resource could be contention-based or contention free.

The (proper) configuration may be received, available, determined, derived, or valid for the UE by one or more of the following:
Carrying via a common signaling (from the network);
Carrying via a dedicated signaling (from the network);
Pre-configured or pre-defined or fixed; and/or
Hybrid of the above.

Any of the above and herein methods, alternatives, concepts, examples, and embodiments may be combined, in whole or in part, or applied simultaneously or separately.

### Signaling Target (UE or UE Group)

The first condition(s) may include that an information related to the UE's UE group (ID) or the UE ID is received or indicated in the NW signaling (as described above, e.g., system information or paging message, or DL command). The information may be (complete or a part of) the UE's UE group (ID) or (complete or a part of) the UE's UE ID. For example, this condition may be fulfilled if (at least) the UE's UE group (ID) is received or indicated in the paging message. This condition may be fulfilled if (at least) the UE's UE ID is received or indicated in the paging message. This condition may be fulfilled if (at least) the UE's UE group (ID) is received or indicated in the system information. This condition may be fulfilled if (at least) (complete or a part of) the UE's UE group (ID) or (complete or a part of) the UE's UE ID is fulfilled by a formula or equals a specific value (indicated in the NW signaling). The formula may be pre-defined or (pre-) configured by the NW or the UE. The UE may determine the UE's UE group (ID) based on the first factor. The UE may determine the UE ID based on the first factor. This condition may not be fulfilled if (at least) an information related to the UE's UE group (ID) or the UE ID is not received or indicated in the NW signaling. This condition may not be fulfilled if (at least) (complete or a part of) the UE's UE group (ID) or (complete or a part of) the UE's UE ID is not fulfilled by the formula or does not equal the specific value (indicated in the NW signaling).

### Available Data or Signaling

The first condition(s) may include that the UE has available data or signaling to transmit. For example, this condition may be fulfilled if (at least) the data or signaling is allowed to be transmitted by the UL procedure or transmission. Not all data or signaling generated by the UE may be allowed to be transmitted by the UL procedure or transmission. This condition may be fulfilled if (at least) there is data or signaling ready to be transmitted by the UE. This condition may be fulfilled if (at least) type of the data or signaling is allowed to be transmitted by the UL procedure or transmission. This condition may be fulfilled if (at least) size of the data or signaling is allowed to be transmitted by the UL procedure or transmission. Whether the type and/or the size is allowed to be transmitted by the UL procedure or transmission may be controlled by the NW (e.g., indicated via the NW signaling as described above). This condition may not be fulfilled if (at least) the UE has no available data and/or signaling allowed to be transmitted by the UL procedure or transmission.

### UE Type

The first condition(s) may include that the type of UE is supported by a cell where the UE camps on. Which type of UE is supported by the cell may be indicated by the cell (e.g., via the NW signaling as described above). For example, this condition may be fulfilled (at least) for a first UE on the (camped) first cell. This condition may not be fulfilled (at least) for a second UE on the (camped) second cell. The second UE may be of the same UE type as the first UE. The first cell and the second cell may be different cells. This condition may be fulfilled (at least) for a third UE on the (camped) first cell. This condition may not be fulfilled (at least) for a third UE on the (camped) first cell. The third UE may be of a different UE type as the first UE. This condition may be fulfilled (at least) for a fourth UE on the (camped) second cell. This condition may not be fulfilled (at least) for a fourth UE on the (camped) second cell. The fourth UE may be of a different UE type as the second UE is. This condition may be fulfilled for a cell if (at least) the UE is a first type of UE. This condition may not be fulfilled for the cell if (at least) the UE is a second type of UE. When the NW signaling indicates support of the first type of UE, if the UE is the first type of UE or if the UE supports the first type of UE, the condition may be fulfilled. If the UE is not the first type of UE or if the UE does not support the first type of UE, the condition may not be fulfilled.

The UE types of the first UE and the second UE may be known by the NW. The UE type supported by the camped cell may be known by the NW.

### Available Resource

The first condition(s) may include that there is an available radio resource for the UL procedure or transmission. A UE may determine (or derive) the available radio resource from at least the configuration. The configuration may be associated with (and/or correspond to) one or more radio resources (pool(s)). Multiple radio resources (pools) may be provided for different configurations. A UE may select/determine radio resources (pools) corresponding to the configuration. The radio resource for UL transmission may be provided periodically. The radio resource for UL transmission may be provided for a single transmission (or aperiodically, or one-shot) (with repetition). The UE may perform a backscattering transmission on the radio resource for the UL transmission. The UE may perform a UL transmission (internally) by itself on the radio resource for the UL transmission.

For example, this condition may be fulfilled if (at least) the radio resource is available for the UL procedure or transmission. This condition may be fulfilled if (at least) the radio resource is provided by the NW. This condition may be fulfilled if (at least) the radio resource is available to the UE. The radio resource for the UL procedure or transmission may be available to multiple UEs. This condition may be fulfilled if (at least) not all available radio resources are occupied at the same time. This condition may not be fulfilled if (at least) the radio resource is not available for the UL procedure or transmission.

The first condition(s) may include that there is an available radio resources for transmitting/comprising the (full) available UE data to transmit. The first condition(s) may include that there is an available radio resources for transmitting a data packet which comprises the (full) available UE data to transmit. A specific Modulation and Coding Scheme (MCS) or indicated/determined MCS may be utilized for checking whether a radio resource is available or not.

### Repetition Number

The first condition(s) may include that the repetition number is determined/selected by the UE. The repetition number may correspond to the number of transmission(s) (e.g., N) of the TB for UL transmission. The UE may perform a new transmission of the TB on the selected/determined radio resource before performing the rest of the retransmission(s) (e.g., for N-1 times) on the selected/determined radio resource. For example, this condition may be fulfilled if (at least) the UE has determined the repetition number (to be used for the UL procedure or transmission), e.g., after performing measurement on a signal. For an instance, the repetition number may be determined if (at least) the signal strength is equal to or larger than a threshold. Alternatively in certain embodiments, the repetition number may be (pre-) configured/indicated by the NW. Alternatively in certain embodiments, the repetition number may be fixed. This condition may not be fulfilled if (at least) the UE has not determined the repetition number (to be used for the UL procedure or transmission), e.g., measurement on the signal is not done yet.

### Power Level

The first condition(s) may include that the power level is fulfilled. For example, this condition may be fulfilled if (at least) a threshold of the power level is fulfilled. This condition may be fulfilled if (at least) the power level is larger than or equal to a threshold. This condition may be fulfilled if (at least) the power level equals a specific value. This condition may not be fulfilled if (at least) the power level is less than or equal to the threshold. This condition may not be fulfilled if (at least) the power level does not equal the specific value. Alternatively in certain embodiments, this condition may be fulfilled if (at least) the power level is smaller than or equal to a threshold. This condition may be fulfilled if (at least) the power level equals a specific value. This condition may not be fulfilled if (at least) the power level is larger than or equal to the threshold. This condition may not be fulfilled if (at least) the power level does not equal the specific value. When determining whether the power level is fulfilled, the repetition number (e.g., to be used for the UL procedure or transmission), a pattern of repetition (e.g., to be used for the UL procedure or transmission), and/or the configuration related to time (e.g., for the end of the carrier wave (signal)) may also be taken into account.

The power level may comprise any one or more of the following embodiments. There may be one or more thresholds for (determining whether) a power level (is fulfilled). The power level may be determined by threshold(s). The threshold(s) for power level may be configured by the network or be derived by the UE. The threshold(s) for power level may be indicated by the cell (e.g., via the NW signaling as described above). The threshold(s) for power level may be determined based on the following embodiments and/or a (selected) UL resource/configuration. The threshold(s) for power level may be indicated or configured by the NW. Alternatively in certain embodiments, the threshold(s) for power level may be determined by the UE. Alternatively in certain embodiments, the threshold(s) for power level may be fixed.

The threshold(s) for power level may be indicated for a configuration of a radio resource pool. The threshold(s) for power level may be indicated for one or more resources.

The UE may utilize a same or different power level embodiment(s) for a different radio resource allocation selection. There may be one or more threshold(s) for power level. The power level may be determined by the threshold(s). The threshold(s) for power level may be configured by the network or be derived by the UE. The threshold(s) for power level may be determined based on the following embodiments.

In one or more embodiments or examples, the power level may be as what is described above (e.g., for the first factor specified above).

For an instance, the first condition may include the received power is equal to or larger than a threshold.

For an instance, the first condition may include the pathloss is equal to or smaller than a threshold.

For an instance, the first condition may include the expected/derived/determined UE transmit power is equal to or larger than a threshold.

For an instance, the first condition may include the expected/derived/determined UE transmit power is equal to or larger than a threshold.

For an instance, the first condition may include the maximum UE transmit power is equal to or larger than a threshold. Alternatively in certain embodiments, the first condition may include the maximum UE transmit power is equal to or smaller than a threshold.

For an instance, the first condition may include a value is equal to or larger than a threshold. The value may be the amount of the UE's battery power/stored power/available power. The value may derived/determined based on the amount of the UE's battery power/stored power/available power and the possible energy charged by the received (incoming) backscattered signal, e.g., a value of “battery power/stored power/available power” plus “the possible energy charged by the received (incoming) backscattered signal”. The value may derived/determined based on the amount of the UE's battery power/stored power/available power and the possible energy charged by the (ongoing) remaining backscattered signal, e.g., a value of “battery power/stored power/available power” plus “the possible energy charged by the (ongoing) remaining backscattered signal”.

For an instance, the first condition may include the UE transmit power is equal to or larger than the predefine/(pre-) configured/indicated power. For an instance, the first condition may include a value is equal to or larger than the predefine/(pre-) configured/indicated power. The value may be derived/determined based on the expected/derived/determined/maximum UE transmit power and the repetition number, e.g., a value of “the expected/derived/determined/maximum UE transmit power” times “the repetition number”.

For an instance, the first condition may include the power difference is equal to or smaller than a threshold or a value. The value may be derived/determined based on the expected/derived/determined/maximum UE transmit power and the repetition number, e.g., a value of “the expected/derived/determined/maximum UE transmit power” times/multiplying “the repetition number”.

For an instance, the first condition may include the power difference is equal to or larger than a threshold or a value. The value may be derived/determined based on the expected/derived/determined/maximum UE transmit power and the repetition number, e.g., a value of “the expected/derived/determined/maximum UE transmit power” times/multiplying “the repetition number”.

For an instance, the first condition may include the power difference is equal to or smaller than a threshold or a value. The value may be derived/determined based on the expected/derived/determined/maximum UE transmit power and the repetition number, e.g., a value of “the expected/derived/determined/maximum UE transmit power” times/multiplying “the repetition number”.

### Available Time

The first condition(s) may include that the current timing is within a time duration associated with the UE or the UE ID. The first condition(s) may include that the current timing is within a time duration associated with the UE's UE group (ID). For example, this condition may be fulfilled for the first UE in a time duration if (at least) the time duration is associated with the UE group (ID) of the first UE. This condition may not be fulfilled for the second UE in the time duration if (at least) the time duration is not associated with the UE group (ID) of the second UE. The UE group of the first UE and the UE group of the second UE may be different. The time duration associated with the UE group of the first UE and the time duration associated with the UE group of the second UE may be different. This condition may be fulfilled if (at least) current timing is within a time duration associated with a UE group (ID) of the UE or with the UE. This condition may not be fulfilled if (at least) the current timing is not within the (or any) time duration associated with a UE group (ID) of the UE or with the UE.

Any of the above and herein methods, alternatives, concepts, examples, and embodiments may be combined, in whole or in part, or applied simultaneously or separately.

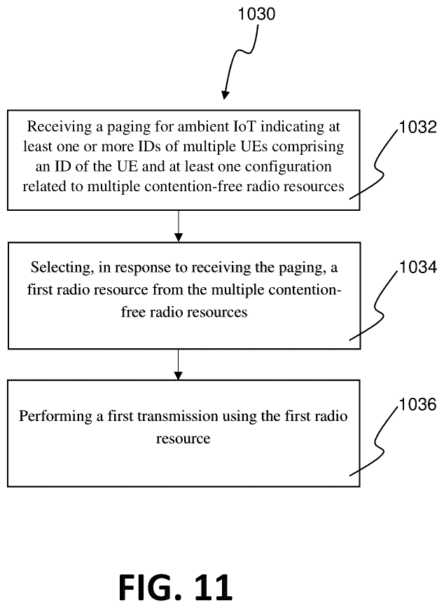

Referring to FIG. 11, with this and other concepts, systems, and methods of the present invention, a method 1030 for a UE in a wireless communication system comprises receiving a paging for ambient IoT indicating at least one or more IDs of multiple UEs comprising an ID of the UE and at least one configuration related to multiple contention-free radio resources (step 1032), selecting, in response to receiving the paging, a first radio resource from the multiple contention-free radio resources (step 1034), and performing a first transmission using the first radio resource (step 1036).

In various embodiments, the UE selects the first radio resource based on an order of the UE indicated in the paging, and wherein the order is associated with the ID of the UE, and/or the order of the UE means an order of the ID of the UE among the one or more IDs of multiple UEs indicated in the paging.

In various embodiments, an order of the first radio resource in the multiple contention-free radio resources is the same as the order of the ID of the UE indicated in the one or more IDs or the order of the UE indicated in the paging.

In various embodiments, the UE selects the first radio resource based on a modulo calculation and (complete or part of) the ID of the UE.

In various embodiments, the first radio resource in the multiple contention-free radio resources is calculated or determined based on (complete or part of) the ID of the UE modulo a number of the multiple contention-free radio resources, and/or an order of the first radio resource in the multiple contention-free radio resources is calculated or determined based on (complete or part of) the ID of the UE modulo the number of the multiple contention-free radio resources, and/or the first radio resource in the multiple contention-free radio resources is calculated or determined based on a derived value of (complete or part of) the ID of the UE modulo the number of the multiple contention-free radio resources.

In various embodiments, the first radio resource is dedicated to the UE and/or the paging is common for the multiple UEs.

In various embodiments, the first radio resource is used by the UE and/or is not used by another UE among the multiple UEs.

In various embodiments, a contention-free radio resource means a radio resource dedicated for a UE or dedicatedly utilized by the UE. A contention-free radio resource is not shared/common utilized by more than one UEs.

In various embodiments, the multiple contention-free radio resources comprise at least time domain radio resources and/or frequency domain radio resources, and/or the multiple contention-free radio resources are determined or derived based on one or more time domain radio resources and/or one or more frequency domain radio resources, and/or the multiple contention-free radio resources are non-overlapped in time-frequency domain.

In various embodiments, the at least one configuration includes at least time domain allocations and/or frequency domain allocations of the multiple contention-free radio resources, and/or the at least one configuration includes an association between the multiple contention-free radio resources and a UE group associated with the UE, and/or the at least one configuration related to the multiple contention-free radio resources means one or more configurations related to the multiple contention-free radio resources.

In various embodiments, the UE performs the first transmission in response to (receiving) the paging.

In various embodiments, the UE performs a random access procedure in response to (receiving) the paging.

In various embodiments, the ID is a UE ID or a group ID.

In various embodiments, the UE ID is pre-configured, pre-defined and/or configured by network.

In various embodiments, the first transmission includes an information of a random number.

In various embodiments, the UE receives a second transmission including the information of the random number, in response to (performing and/or transmitting) the first transmission.

In various embodiments, the paging and/or the second transmission is received from a reader.

In various embodiments, the first transmission is transmitted to the reader.

In various embodiments, the reader is a network node or another UE (not among the multiple UEs).

In various embodiments, the UE is an ambient IoT device. The multiple UEs are multiple ambient IoT devices.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) receive a paging for ambient IoT indicating at least one or more IDs of multiple UEs comprising an ID of the UE and at least one configuration related to multiple contention-free radio resources; (ii) select, in response to receiving the paging, a first radio resource from the multiple contention-free radio resources; and (iii) perform a first transmission using the first radio resource. Moreover, the CPU 308 can execute the program code 312 to perform all of the described actions, steps, and methods described above, below, or otherwise herein.

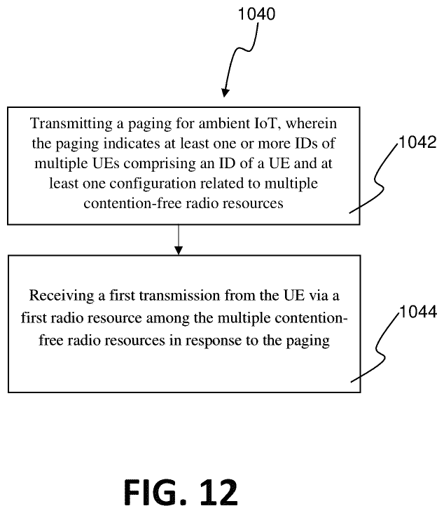

Referring to FIG. 12, with this and other concepts, systems, and methods of the present invention, a method 1040 for a reader in a wireless communication system comprises transmitting a paging for ambient IoT, wherein the paging indicates at least one or more IDs of multiple UEs comprising an ID of a UE and at least one configuration related to multiple contention-free radio resources (step 1042), and receiving a first transmission from the UE via a first radio resource among the multiple contention-free radio resources in response to the paging (step 1044).

In various embodiments, an order of the first radio resource in the multiple contention-free radio resources is the same as an order of the ID of the UE indicated in the ID or an order of the UE indicated in the paging.

In various embodiments, the first radio resource in the multiple contention-free radio resources is assigned or determined based on (complete or part of) the ID of the UE modulo a number of the multiple contention-free radio resources, and/or an order of the first radio resource in the multiple contention-free radio resources is assigned or determined based on (complete or part of) the ID of the UE modulo the number of the multiple contention-free radio resources, and/or the first radio resource in the multiple contention-free radio resources is assigned or determined based on a derived value of (complete or part of) the ID of the UE modulo the number of the multiple contention-free radio resources.

In various embodiments, the paging is transmitted to the multiple UEs and/or the paging is common for the multiple UEs.

In various embodiments, the first radio resource is dedicated and/or assigned to the UE.

In various embodiments, the first radio resource is used by the UE and/or is not used by another UE among the multiple UEs.

In various embodiments, a contention-free radio resource means a radio resource dedicated for a UE or dedicatedly utilized by the UE. A contention-free radio resource is not shared/common utilized by more than one UEs.

In various embodiments, the multiple contention-free radio resources comprise at least time domain radio resources and/or frequency domain radio resources, and/or the multiple contention-free radio resources are determined or derived based on one or more time domain radio resources and/or one or more frequency domain radio resources, and/or the multiple contention-free radio resources are non-overlapped in time-frequency domain.

In various embodiments, the at least one configuration includes at least time domain allocations and/or frequency domain allocations of the multiple contention-free radio resources, and/or the at least one configuration includes an association between the multiple contention-free radio resources and a UE group associated with the UE, and/or the at least one configuration related to the multiple contention-free radio resources means one or more configurations related to the multiple contention-free radio resources.

In various embodiments, the reader is a network node or another UE (not among the multiple UEs).

In various embodiments, the ID is a UE ID or a group ID.

In various embodiments, the UE ID is pre-configured, pre-defined and/or configured by network.

In various embodiments, the first transmission includes an information of a random number.

In various embodiments, the reader transmits a second transmission to the UE including the information of the random number, in response to (receiving) the first transmission.

In various embodiments, the UE is an ambient IoT device. The multiple UEs are multiple ambient IoT devices.

Referring back to FIGS. 3 and 4, in one or more embodiments from the perspective of a reader in a wireless communication system, the device 300 includes a program code 312 stored in memory 310 of the transmitter. The CPU 308 could execute program code 312 to: (i) transmit a paging for ambient IoT, wherein the paging indicates at least one or more IDs of multiple UEs comprising an ID of a UE and at least one configuration related to multiple contention-free radio resources; and (ii) receive a first transmission from the UE via a first radio resource among the multiple contention-free radio resources in response to the paging. Moreover, the CPU 308 can execute the program code 312 to perform all of the described actions, steps, and methods described above, below, or otherwise herein.

Any combination of the above or herein concepts or teachings can be jointly combined, in whole or in part, or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method of a User Equipment (UE), comprising:
receiving a paging for ambient Internet of Things (IoT) indicating at least one or more Identifications (IDs) of multiple UEs comprising an ID of the UE and at least one configuration related to multiple contention-free radio resources;
selecting, in response to receiving the paging, a first radio resource from the multiple contention-free radio resources; and
performing a first transmission using the first radio resource.

2. The method of claim 1, wherein:
the UE selects the first radio resource based on an order of the UE indicated in the paging, and wherein the order is associated with the ID of the UE, and/or
the order of the UE means an order of the ID of the UE among the one or more IDs of the multiple UEs indicated in the paging.

3. The method of claim 2, wherein an order of the first radio resource in the multiple contention-free radio resources is the same as the order of the ID of the UE indicated in the one or more IDs or the order of the UE indicated in the paging.

4. The method of claim 1, wherein the UE selects the first radio resource based on a modulo calculation and the ID of the UE.

5. The method of claim 4, wherein:
the first radio resource in the multiple contention-free radio resources is calculated or determined based on the ID of the UE modulo a number of the multiple contention-free radio resources, and/or
an order of the first radio resource in the multiple contention-free radio resources is calculated or determined based on the ID of the UE modulo the number of the multiple contention-free radio resources, and/or
the first radio resource in the multiple contention-free radio resources is calculated or determined based on a derived value of the ID of the UE modulo the number of the multiple contention-free radio resources.

6. The method of claim 1, wherein:
the multiple contention-free radio resources comprise at least time domain radio resources and/or frequency domain radio resources, and/or
the multiple contention-free radio resources are determined or derived based on one or more time domain radio resources and/or one or more frequency domain radio resources, and/or
the multiple contention-free radio resources are non-overlapped in time-frequency domain.

7. The method of claim 1, wherein:
the at least one configuration includes at least time domain allocations and/or frequency domain allocations of the multiple contention-free radio resources, and/or
the at least one configuration includes an association between the multiple contention-free radio resources and a UE group associated with the UE, and/or
the at least one configuration related to the multiple contention-free radio resources means one or more configurations related to the multiple contention-free radio resources.

8. The method of claim 1, wherein the UE performs the first transmission in response to the paging.

9. The method of claim 1, wherein the UE performs a random access procedure in response to the paging.

10. The method of claim 1, wherein the ID is a UE ID or a group ID.

11. The method of claim 1, wherein the first transmission includes an information of a random number.

12. A method of a reader, comprising:
transmitting a paging for ambient Internet of Things (IoT), wherein the paging indicates at least one or more Identifications (IDs) of multiple User Equipment (UEs) comprising an ID of a UE and at least one configuration related to multiple contention-free radio resources; and
receiving a first transmission from the UE via a first radio resource among the multiple contention-free radio resources in response to the paging.

13. The method of claim 12, wherein an order of the first radio resource in the multiple contention-free radio resources is the same as an order of the ID of the UE indicated in the ID or an order of the UE indicated in the paging.

14. The method of claim 12, wherein:
the first radio resource in the multiple contention-free radio resources is assigned or determined based on the ID of the UE modulo a number of the multiple contention-free radio resources, and/or
an order of the first radio resource in the multiple contention-free radio resources is assigned or determined based on the ID of the UE modulo the number of the multiple contention-free radio resources, and/or
the first radio resource in the multiple contention-free radio resources is assigned or determined based on a derived value of the ID of the UE modulo the number of the multiple contention-free radio resources.

15. The method of claim 12, wherein:
the multiple contention-free radio resources comprise at least time domain radio resources and/or frequency domain radio resources, and/or
the multiple contention-free radio resources are determined or derived based on one or more time domain radio resources and/or one or more frequency domain radio resources, and/or
the multiple contention-free radio resources are non-overlapped in time-frequency domain.

16. The method of claim 12, wherein:
the at least one configuration includes at least time domain allocations and/or frequency domain allocations of the multiple contention-free radio resources, and/or
the at least one configuration includes an association between the multiple contention-free radio resources and a UE group associated with the UE, and/or
the at least one configuration related to the multiple contention-free radio resources means one or more configurations related to the multiple contention-free radio resources.

17. The method of claim 12, wherein the reader is a network node or another UE.

18. The method of claim 12, wherein the ID is a UE ID or a group ID.

19. The method of claim 12, wherein the first transmission includes an information of a random number.

20. A User Equipment (UE), comprising:
a memory; and
a processor operatively coupled with the memory, wherein the processor is configured to execute a program code to:
receive a paging for ambient Internet of Things (IoT) indicating at least one or more Identifications (IDs) of multiple UEs comprising an ID of the UE and at least one configuration related to multiple contention-free radio resources;
select, in response to receiving the paging, a first radio resource from the multiple contention-free radio resources; and
perform a first transmission using the first radio resource.
